(19) United States
(12) Patent Application Publication
(10) Pub. No.: US 2025/0029050 A1
(43) Pub. Date: Jan. 23, 2025

(54) COMPUTERIZED SYSTEMS AND METHODS FOR PREDICTIVE RESOURCE CONTROL AND ALLOCATION FROM A CENTRALIZED DATABASE

(71) Applicant: VIZIENT, INC., Irving, TX (US)

(72) Inventors: Diane Agerton Dyess, Haltom City, TX (US); Joel Walter Denton, Cedar Hill, TX (US); Andrew William Dubowec, Toronto (CA); Shawn Michael Fleming, Dallas, TX (US); Justin Jerry Hibbs, Grapevine, TX (US); Troy Wayne Kirchenbauer, Hurst, TX (US); Peter Laundy, Evanston, IL (US); Russell Francis Lewis, Dallas, TX (US); John Walter Mallinckrodt, II, Dallas, TX (US); Krzysztof Musial, West Bloomfield, MI (US); Harpreet Singh, Boerne, TX (US); Scott Michael Willey, Lewisville, TX (US)

(21) Appl. No.: 18/755,202

(22) Filed: Jun. 26, 2024

Related U.S. Application Data
(63) Continuation of application No. 17/364,198, filed on Jun. 30, 2021, now abandoned.
Application No. 17/364,198 is a continuation of application No. 15/783,992, filed on Oct. 13, 2017, now abandoned.
Application No. 15/783,992 is a division of application No. 13/765,507, filed on Feb. 12, 2013, now abandoned.
(60) Provisional application No. 61/611,317, filed on Mar. 15, 2012.
(60) Provisional application No. 61/611,306, filed on Mar. 15, 2012.
(60) Provisional application No. 61/611,302, filed on Mar. 15, 2012.
(60) Provisional application No. 61/611,317, filed on Mar. 15, 2012.
(60) Provisional application No. 61/611,312, filed on Mar. 15, 2012.
(60) Provisional application No. 61/611,311, filed on Mar. 15, 2012.
(60) Provisional application No. 61/611,306, filed on Mar. 15, 2012.
(60) Provisional application No. 61/611,302, filed on Mar. 15, 2012.
(60) Provisional application No. 61/611,312, filed on Mar. 15, 2012.
(60) Provisional application No. 61/611,311, filed on Mar. 15, 2012.
(60) Provisional application No. 61/611,317, filed on Mar. 15, 2012.
(60) Provisional application No. 61/611,312, filed on Mar. 15, 2012.
(60) Provisional application No. 61/611,311, filed on Mar. 15, 2012.
(60) Provisional application No. 61/611,306, filed on Mar. 15, 2012.
(60) Provisional application No. 61/611,302, filed on Mar. 15, 2012.

(51) Int. Cl. G06Q 10/08; G06F 3/048; G06Q 10/0631; G06Q 30/0201; G06Q 30/0601; G06Q 40/00

(52) U.S. Cl. CPC G06Q 10/08; G06F 3/048; G06Q 10/06315; G06Q 30/0206; G06Q 30/0605; G06Q 30/0609; G06Q 30/0611; G06Q 30/0613; G06Q 30/0623; G06Q 30/0631; G06Q 30/0633; G06Q 40/00

(57) ABSTRACT

In some embodiments, the present invention provides an exemplary computer system that includes at least the following components: at least one processor; a non-transitory memory storing software instructions; and where, when executing the software instructions by the processor, the computer system is configured to perform at least: controlling a plurality of first software objects; controlling a plurality of second software objects; controlling a plurality of third software object; where each software object includes at least one property programmed with at least one trigger condition and at least one programmed action; where the at least one pre-programmed action is configured to dynamically change a value of at least one property of at least one other software object based on: i) the at least one trigger condition; and ii) a value of at least one other property.

### CROSS-REFERENCE TO RELATED APPLICATIONS

This application is a continuation of U.S. patent application Ser. No. 17/364,198, filed Jun. 30, 2021, which is a continuation of U.S. patent application Ser. No. 15/783,992, filed Oct. 13, 2017, which is a divisional of U.S. patent application Ser. No. 13/765,507, filed Feb. 12, 2013, now abandoned, a divisional of U.S. patent application Ser. No. 13/765,271, filed Feb. 12, 2013, now abandoned, and a divisional of U.S. patent application Ser. No. 13/765,479, filed Feb. 12, 2013, now abandoned, all which claim the benefit of priority from U.S. Provisional Application No. 61/611,317, filed Mar. 15, 2012, U.S. Provisional Patent Application No. 61/611,312, filed Mar. 15, 2012, U.S. Provisional Patent Application No. 61/611,311, filed Mar. 15, 2012, U.S. Provisional Application No. 61/611,306, filed Mar. 15, 2012, and U.S. Provisional Patent Application No. 61/611,302, filed Mar. 15, 2012, which are each incorporated by reference herein in their entirety.

### TECHNOLOGICAL FIELD

Example embodiments of the present invention relate generally to computer-based systems and apparatuses configured to manage software objects that are interrelated via trigger conditions, and methods of use thereof.

### BRIEF SUMMARY

In some embodiments, the present invention provides an exemplary computer-implemented method that includes at least the following steps of: instructing a processor to execute a plurality of software instructions so that the processor is configured to perform at least the following computer operations: controlling, by the processor, a plurality of first software objects; controlling, by the processor, a plurality of second software objects; controlling, by the processor, a plurality of third software object; where each first software object includes: at least one first property programmed with at least one trigger condition and at least one programmed action; where the at least one pre-programmed action is configured to dynamically change a value of the at least one second property of at least one second software object of the plurality of second software objects based at least in part on: i) the at least one trigger condition and ii) a value of at least one third property of at least one corresponding third software object of the plurality of third software objects; obtaining, by the processor, first data related to the value of the at least one second property of at least one second software object of the plurality of second software objects; determining, by the processor, a state of the at least one trigger condition of the at least one first property based at least in part on the first data; executing, by the processor, the least one pre-programmed action when the state of the at least one trigger condition indicates, based at least in part on the first data, that the at least one trigger condition has been met so to result in the change in the value of the at least one second property of at least one second software object of the plurality of second software objects; and outputting, by the processor, at least one electronic notification identifying the change in the value of the at least one second property of at least one second software object of the plurality of second software objects.

In some embodiments, the present invention provides an exemplary computer system that includes at least the following components: at least one processor; a non-transitory memory storing software instructions; and where, when executing the software instructions by the processor, the computer system is configured to perform at least the following computer operations: controlling, by the processor, a plurality of first software objects; controlling, by the processor, a plurality of second software objects; controlling, by the processor, a plurality of third software object; where each first software object at least includes: at least one first property programmed with at least one trigger condition and at least one programmed action; where the at least one pre-programmed action is configured to dynamically change a value of the at least one second property of at least one second software object of the plurality of second software objects based at least in part on: i) the at least one trigger condition and ii) a value of at least one third property of at least one corresponding third software object of the plurality of third software objects; obtaining, by the processor, first data related to the value of the at least one second property of at least one second software object of the plurality of second software objects; determining, by the processor, a state of the at least one trigger condition of the at least one first property based at least in part on the first data; executing, by the processor, the least one pre-programmed action when the state of the at least one trigger condition indicates, based at least in part on the first data, that the at least one trigger condition has been met so to result in the change in the value of the at least one second property of at least one second software object of the plurality of second software objects; and outputting, by the processor, at least one electronic notification identifying the change in the value of the at least one second property of at least one second software object of the plurality of second software objects.

In some embodiments, each first software object of the plurality of first software objects at least includes a multi-dimension array, where each axis of the multi-dimension array corresponds to a parameter of a dynamic pricing model; where each second software object of the plurality of second software objects at least includes data representative of a supply arrangement between a buyer and a seller for at least one product; where the at least one second property of the at least one second software object is a particular term of the supply arrangement; where each third software object of the plurality of third software objects at least includes data representative of at least one purchase order for the at least one product; where the at least one third property of the at least one third software object is a particular term of the at least one purchase order; and where the at least one trigger condition is at least one compliance condition related to the particular term of the supply arrangement.

In some embodiments, the particular term of the supply arrangement defines at least one market share level.

In some embodiments, the particular term of the at least one purchase order is a price of the at least one product.

In some embodiments, the parameter of the dynamic pricing model is selected from the group consisting of a discount level within a category, a market share commitment level, and a sales volume level.

In some embodiments, the at least one pre-programmed action Is configured to dynamically change the price of the at least one purchase order.

In some embodiments, the particular term of the at least one purchase order is a price of the at least one product; and where the at least one pre-programmed action is configured to dynamically change the price of the at least one purchase order.

In some embodiments, the exemplary method further includes: tracking, by the processor, the state of the at least one trigger condition over a pre-determined time period.

In some embodiments, the exemplary computer system is further configured to perform at least the following computer operations: tracking, by the processor, the state of the at least one trigger condition over a pre-determined time period.

In some embodiments, the outputting of the at least one electronic notification identifying the change in the value of the at least one second property of the at least one second software object of the plurality of second software objects, further including: displaying the at least one electronic notification via a programmed user graphical interface on a screen of a computing device.

In some embodiments, the at least one electronic notification is a visual software object configured to show the change in the value of the at least one second property of at least one second software object of the plurality of second software objects over a pre-determined time period.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE DRAWINGS

Having thus described certain embodiments of the invention in general terms, reference will now be made to the accompanying drawings, which are not necessarily drawn to scale, and wherein:

FIGS. 1-3 depict block diagrams representative of certain aspects in accordance with some example embodiments;

FIGS. 4-11 depict screen captures representative of certain aspects of in accordance with some example embodiments;

FIG. 12 depicts a computer interface in accordance with some example embodiments;

FIG. 13 depicts a flow diagram of an example method in accordance with some example embodiments;

FIG. 14 depicts a screen capture representative of certain aspects of some example embodiments;

FIG. 15 depicts a block diagram representative of certain aspects of in accordance with some example embodiments;

FIGS. 16-22 depict screen captures representative of certain aspects in accordance with some example embodiments;

FIG. 23 depicts a flow diagram of an example method in accordance with some example embodiments;

FIGS. 24-28 depict screen captures representative of certain aspects in accordance with some example embodiments; and

FIGS. 29-30 depict a flow diagram of an example method in accordance with some example embodiments.

### DETAILED DESCRIPTION

Aspects of the disclosure include an integrated platform.

In some embodiments, the present invention provides an exemplary computer-implemented method that includes at least the following steps of: instructing a processor to execute a plurality of software instructions so that the processor is configured to perform at least the following computer operations: controlling, by the processor, a plurality of first software objects; controlling, by the processor, a plurality of second software objects; controlling, by the processor, a plurality of third software object; where each first software object includes: at least one first property programmed with at least one trigger condition and at least one programmed action; where the at least one pre-programmed action is configured to dynamically change a value of the at least one second property of at least one second software object of the plurality of second software objects based at least in part on: i) the at least one trigger condition and ii) a value of at least one third property of at least one corresponding third software object of the plurality of third software objects; obtaining, by the processor, first data related to the value of the at least one second property of at least one second software object of the plurality of second software objects; determining, by the processor, a state of the at least one trigger condition of the at least one first property based at least in part on the first data; executing, by the processor, the least one pre-programmed action when the state of the at least one trigger condition indicates, based at least in part on the first data, that the at least one trigger condition has been met so to result in the change in the value of the at least one second property of at least one second software object of the plurality of second software objects; and outputting, by the processor, at least one electronic notification identifying the change in the value of the at least one second property of at least one second software object of the plurality of second software objects.

In some embodiments, the present invention provides an exemplary computer system that includes at least the following components: at least one processor; a non-transitory memory storing software instructions; and where, when executing the software instructions by the processor, the computer system is configured to perform at least the following computer operations: controlling, by the processor, a plurality of first software objects; controlling, by the processor, a plurality of second software objects; controlling, by the processor, a plurality of third software object; where each first software object at least includes: at least one first property programmed with at least one trigger condition and at least one programmed action; where the at least one pre-programmed action is configured to dynamically change a value of the at least one second property of at least one second software object of the plurality of second software objects based at least in part on: i) the at least one trigger condition and ii) a value of at least one third property of at least one corresponding third software object of the plurality of third software objects; obtaining, by the processor, first data related to the value of the at least one second property of at least one second software object of the plurality of second software objects; determining, by the processor, a state of the at least one trigger condition of the at least one first property based at least in part on the first data; executing, by the processor, the least one pre-programmed action when the state of the at least one trigger condition indicates, based at least in part on the first data, that the at least one trigger condition has been met so to result in the change in the value of the at least one second property of at least one second software object of the plurality of second software objects; and outputting, by the processor, at least one electronic notification identifying the change in the value of the at least one second property of at least one second software object of the plurality of second software objects.

In some embodiments, each first software object of the plurality of first software objects at least includes a multi-dimension array, where each axis of the multi-dimension array corresponds to a parameter of a dynamic pricing model; where each second software object of the plurality of second software objects at least includes data representative of a supply arrangement between a buyer and a seller for at least one product; where the at least one second property of the at least one second software object is a particular term of the supply arrangement; where each third software object of the plurality of third software objects at least includes data representative of at least one purchase order for the at least one product; where the at least one third property of the at least one third software object is a particular term of the at least one purchase order; and where the at least one trigger condition is at least one compliance condition related to the particular term of the supply arrangement.

In some embodiments, the particular term of the supply arrangement defines at least one market share level.

In some embodiments, the particular term of the at least one purchase order is a price of the at least one product.

In some embodiments, the parameter of the dynamic pricing model is selected from the group consisting of a discount level within a category, a market share commitment level, and a sales volume level.

In some embodiments, the at least one pre-programmed action Is configured to dynamically change the price of the at least one purchase order.

In some embodiments, the particular term of the at least one purchase order is a price of the at least one product; and where the at least one pre-programmed action is configured to dynamically change the price of the at least one purchase order.

In some embodiments, the exemplary method further includes: tracking, by the processor, the state of the at least one trigger condition over a pre-determined time period.

In some embodiments, the exemplary computer system is further configured to perform at least the following computer operations: tracking, by the processor, the state of the at least one trigger condition over a pre-determined time period.

In some embodiments, the outputting of the at least one electronic notification identifying the change in the value of the at least one second property of the at least one second software object of the plurality of second software objects, further including: displaying the at least one electronic notification via a programmed user graphical interface on a screen of a computing device.

In some embodiments, the at least one electronic notification is a visual software object configured to show the change in the value of the at least one second property of at least one second software object of the plurality of second software objects over a pre-determined time period.

The market platform in may provide buyers and suppliers with information about a particular market (e.g., healthcare, pharmaceuticals, construction, office supplies, etc.), allowing the buyers and suppliers to enter informed decisions regarding purchase and supply contracts. The market platform may further provide capabilities for optimization, selection, and management of these contracts. Contracts entered between buyers and suppliers may be monitored by the market platform to ensure compliance with the terms of the contracts. Example embodiments may include methods, systems, apparatuses, and computer program products for leveraging access to buyer spend data to implement a system that allows customers to select a purchase plan that most meets their needs, while also measuring and/or enforcing compliance with contract terms. Such a system benefits both buyer and suppliers, as buyers are offered multiple options to optimize their spending patterns, while suppliers are ensured contract compliance, allowing them to offer optimal pricing to buyers.

Some example embodiments provide systems, methods, apparatus, and computer program products for providing a market platform. The market platform may operate to inform buyers and suppliers, to allow buyers and suppliers to select products and contracting parameters to meet their needs, to allow buyers and suppliers to commit to supply agreements, and to monitor compliance with and enforce those supply agreements. For the purposes of this application, the term “products” is intended to have broad meaning, including but not limited to tangible and intangible goods within the healthcare domain. Examples of these products may include medical supplies and devices, physician preference items, pharmaceuticals, capital, services, and the like.

Embodiments of an aspect of the present invention may provide such an integrated system by receiving buyer spend data, generating a request for pricing, receiving contract offers from one or more suppliers based on the spend data, allowing the buyer to select one or more of the contract offers, and monitoring spend data to inform and/or enforce compliance with the selected contract offer. The system may include dynamic pricing models, altering the price of the purchased products based on compliance with the selected contract offer. The system may also allow for various contracting models for managing the pricing of products or providing other financial benefits to buyers and/or suppliers based on the contractual terms agreed to by the buyer and supplier. These financial benefits may include price discounts, rebate payments, escrow refunds, insurance premiums or benefits, or any other type of financial benefit agreed to by the buyer and supplier. The system may also provide the buyer with a plurality of contracting options across plurality of suppliers, including determining an optimal contracting mix for the buyer based on one or more criteria, such as minimizing aggregate cost, minimizing the number of suppliers, minimizing product conversions maintaining relationships with one or more preferred suppliers, or the like. In this manner, embodiments may provide a complete, closed-loop market ecosystem that benefits both buyers and suppliers.

Some example embodiments provide a method for purchase planning. The method may include receiving one or more pricing proposals for at least one proposed product, and generating a spending plan based on the one or more pricing proposals. The spending plan may include a set of product selections and a product spending allocation for each of the product selections. The set of product selections may include a list of products available for purchase according to at least one of the one or more pricing proposals. The method may further include presenting the spending plan via an interface, receiving, via the interface, an alteration to at least one of one of the product selections or one of the product spending allocations, determining, using a processor, the financial impact of the alteration on the spending plan, and updating the spending plan to reflect the financial impact.

Some example embodiments may further provide an apparatus for purchase planning. The apparatus may include at least one processor and at least one computer readable medium. The computer readable medium may include instructions, that when executed by the processor, configure the processor to receive one or more pricing proposals for at least one proposed product, and generate a spending plan based on the one or more pricing proposals. The spending plan may include a set of product selections and a product spending allocation for each of the product selections. The set of product selections may include a list of products available for purchase according to at least one of the one or more pricing proposals. The processor may be further configured to present the spending plan via an interface, receive, via the interface, an alteration to at least one of one of the product selections or one of the product spending allocations, determine the financial impact of the alteration on the spending plan, and update the spending plan to reflect the financial impact.

Some example embodiments may further provide a computer readable storage medium for purchase planning. The computer readable storage medium may include instructions that, when executed by a processor, configure the processor to receive one or more pricing proposals for at least one proposed product, and generate a spending plan based on the one or more pricing proposals. The spending plan may include a set of product selections and a product spending allocation for each of the product selections. The set of product selections may include a list of products available for purchase according to at least one of the one or more pricing proposals. The processor may be further configured to present the spending plan via an interface, receive, via the interface, an alteration to at least one of one of the product selections or one of the product spending allocations, determine the financial impact of the alteration on the spending plan, and update the spending plan to reflect the financial impact.

Some example embodiments provide a method for implementing a market platform. The method may include receiving a set of buyer needs. The buyer needs may identify at least one product. The method may also include receiving a plurality of contracts from one or more suppliers of the at least one product. The plurality of contracts may reflect terms under which the supplier agrees to provide the at least one product to the buyer. The method may further include determining, using a processor, a plurality of subsets of the plurality of contracts, each of the subsets meeting the set of buyer needs, determining a value for one or more of the plurality of subsets, identifying one or more optimized subsets of the plurality of subsets based on the value of each of the particular subsets, and providing the one or more optimized subsets to the buyer.

Example embodiments may further provide an apparatus for a market platform. The apparatus may include at least one processor and at least one computer readable medium. The computer readable medium may include instructions, that when executed by the processor, configure the processor. The processor may be configured by the instructions to receive a set of buyer needs. The buyer needs may identify at least one product. The apparatus may further be configured to receive a plurality of contracts from one or more suppliers of the at least one product. The plurality of contracts may reflect terms under which the supplier agrees to provide the at least one product to the buyer. The apparatus may also determine a plurality of subsets of the plurality of contracts. Each of the subsets may meet the set of buyer needs. The apparatus may further determine a value for one or more of the plurality of subsets, identify one or more optimized subsets of the plurality of subsets based on the value of each of the particular subsets, and provide the one or more optimized subsets to the buyer.

Example embodiments may further provide a computer readable storage medium comprising instructions comprising instructions that, when executed by a processor, cause the processor to perform a method. The instructions may configure the processor to receive a set of buyer needs. The buyer needs may identify at least one product. The instructions may further configure the processor to receive a plurality of contracts from one or more suppliers of the at least one product. The plurality of contracts may reflect terms under which the supplier agrees to provide the at least one product to the buyer. The instructions may further configure the processor to determine a plurality of subsets of the plurality of contracts. Each of the subsets may meet the set of buyer needs. The instructions may further configure the processor to determine a value for one or more of the plurality of subsets, identify one or more optimized subsets of the plurality of subsets based on the value of each of the particular subsets, and provide the one or more optimized subsets to the buyer.

Embodiments may include a pricing module that allows for establishing prices or sets of prices based on objective price criteria established by the supplier. The pricing module may allow a supplier to specify a particular discount level, and apply criteria to adjust the discount level to generate a pricing model. The pricing module may apply the pricing model to a particular product or set of products in response to an RFP initiated by the buyer to generate a price response. The pricing module may further allow for adjustment of the pricing model based on the characteristics of the particular buyer. The pricing module may also allow for saving of pricing models for future use, resulting in the ability to reuse pricing models for future RFPs from both the particular buyer and other buyers.

Some example embodiments may provide a method for implementing a pricing utility.

The method may include receiving a set of discount terms. The set of discount terms may define a discount level associated with one or more contract parameters. Each of the one or more contract parameters may be associated with one or more particular parameter values. The method may further include generating a pricing model from the set of discount terms, receiving product price information for one or more products, and generating, using a processor, a price response by applying the pricing model to the product price information. The price response may define a relationship between the one or more contract parameters and a set of discounted prices for the one or more products.

Some example embodiments may provide an apparatus for implementing a pricing utility. The apparatus may include at least one processor and at least one computer readable storage medium. The computer readable medium may include instructions, that when executed by the processor, configure the processor. The processor may be configured to receive a set of discount terms. The set of discount terms may define a discount level associated with one or more contract parameters. Each of the one or more contract parameters may be associated with one or more particular parameter values. The processor may be further configured to generate a pricing model from the set of discount terms, receive product price information for one or more products, and generate a price response by applying the pricing model to the product price information. The price response may define a relationship between the one or more contract parameters and a set of discounted prices for the one or more products.

Some example embodiments may provide a computer readable storage medium for implementing a pricing utility. The computer readable storage medium may include instructions that, when executed by a processor, configure the processor to receive a set of discount terms. The set of discount terms may define a discount level associated with one or more contract parameters. Each of the one or more contract parameters may be associated with one or more particular parameter values. The processor may be further configured to generate a pricing model from the set of discount terms, receive product price information for one or more products, and generate a price response by applying the pricing model to the product price information. The price response may define a relationship between the one or more contract parameters and a set of discounted prices for the one or more products.

The market platform may provide for efficient pricing and management of responses to RFPs prepared by buyers. In this regard, the market platform may provide interfaces for establishing product prices based on various factors, such as product category, market share commitment of the buyer, contract type and duration, and the like. An interface may be provided that allows for efficient management of these different parameters to provide buyers with a variety of options to allow for efficient allocation of purchase agreements. These parameters may include both fixed parameters (e.g., contract duration) and variable parameters (e.g., buyer spend in a particular category). The market platform may include monitoring and adjustment based on both types of parameters, including applying dynamic adjustments based on variable parameters as these parameters change.

The market platform may also provide an interface for buyers to consider contract pricing proposals prepared by multiple suppliers, and to simulate the effects of various levels of market share commitment and product allocation across the proposals prepared by the suppliers. The buyer may be provided with the capability to optimize a set of contracts from among contracts offered by the suppliers that best meet the needs of the buyer. These optimizations may include minimizing overall cost, best savings with a particular supplier, minimizing conversion from a current set of suppliers, and minimizing the number of suppliers. Product cross-reference functionality may also be provided to allow for efficient purchase planning and selection of alternative products in a particular category.

The market platform may also provide an interface for buyers to consider contract pricing proposals received from multiple suppliers, and to simulate the effects of different contract performance parameters on said pricing proposals. Although this process may be optional for generating contracts using the market platform, it may impart useful data to buyers to assist with the contracting process. The market platform may thus provide buyers with the ability to test the impact of various contracting scenarios on their planned spending. The market platform may also advantageously provide a flexible interface that allows buyers to select product allocations that are as aggressive (e.g., commitment levels that may be more difficult for the buyer to meet) or conservative (e.g., commitment levels the buyer may have an easier time in meeting) as the buyer desires. Additionally, buyers may adjust their planned spending to account for their own unique needs (e.g., a desire to maintain a relationship with a particular supplier or to fulfill the needs of a particular practitioner who desires a certain make/model of a product).

For example, the buyer may receive a set of contract proposals from several suppliers, with each supplier offering different products and discount terms at certain contract performance levels (e.g., market share commitment, sales volume, etc.). The market platform may display an initial product allocation to the buyer based on the received contract pricing proposals. For example, the market platform may analyze a historical spending history of the buyer and identify which products and contract performance levels the buyer is currently attaining. This initial product allocation may be presented to the buyer via an interface that allows the buyer to adjust contract performance levels (e.g., to adjust contract durations), to select alternative products (e.g., to select products from another seller, or to select a different product from the same seller), to allocate spending to particular products (e.g., 50% of the buyer's purchasing for a particular group of products will be allocated to product A, 20% to product B, and 30% to product C) or to otherwise adjust planned spending. As the buyer updates these values, they may be provided with dynamic updates to estimated discount levels and overall spending for the products that are being analyzed. The market platform may also provide the buyer with the ability to optimize their spending for certain optimization parameters based on the pricing proposals received. The market platform may thus assist the buyer with selecting a group of products for purchasing based on responses received from an RFP, and allocating the buyer's spending across the selected products. The result of this planning may be a purchase plan, which includes a specific set of selected products and spending allocations among the set of selected products.

The purchase plan may also include data indicating a target market share commitment for particular suppliers, where the target market share commitment is derived from the selected products and spending allocations. The buyer may be presented with the ability to modify these values manually, or to allow the market platform to optimize the selections based on various factors. For example, the buyer may elect to generate a purchase plan that represents a selection of products and spending allocations that optimize the buyer's overall costs among the pricing proposals received, the buyer may elect to generate a purchase plan that optimizes their discount level with a particular supplier, or the buyer may elect to generate a purchase plan that stays as close as possible to the buyer's current spending allocations. The market platform may also provide the buyer with the ability to modify the purchase plan generated by these optimizations, including “locking” data associated with certain suppliers or product allocations and optimizing for the remaining, “unlocked” suppliers or product allocations. In this manner, the market platform provides buyers with the ability to plan their purchases in order to have a high degree of certainty that contract performance goals can be met, while also allowing continued monitoring of buyer spending against a determined plan to allow the buyer to monitor how their purchasing matches up with the original planned purchases.

The market platform may further operate to identify product cross-references for use in generation of these purchase plans. For example, different suppliers may sell similar products, each with a model number associated with the respective supplier. The market platform may allow for suppliers to note which of their products are similar to their competitor's products, so that the buyer may be presented with the option to select one or more of the supplier's products instead of the competitor's product. The market platform may examine buyer spend history to identify these cross-references. For example, the market platform may identify to the buyer which products are currently purchased by the buyer, and any products which have been identified by competitors as valid cross-references to the products purchased by the buyer. During the purchase planning process, buyers may be presented with cross-references from competitors that responded to the RFP.

Product cross-references may also be identified by other methods. The market platform may have the ability to analyze buyer spend data or purchase plans from other buyers and to determine which products are frequently selected as cross-reference items by the other buyers. These cross-references may be presented to the buyer during the purchase planning process as “community” or “crowd-sourced” cross-references. Additionally or alternatively, cross-references may be determined by product ratings, by explicit selection by the buyer, or by any other method for identifying similar products both within the same supplier and across different suppliers.

Suppliers may utilize the market platform to generate price models for products. In the context of this application, the term “product” should be understood not only to encompass individual items provided by the supplier, but also sets of items (e.g., several items sold as a group or kit), services (e.g., labor or staffing needs), and various other tangible and intangible goods and services which may be procured according to a supply contract. Price models may be generated based on or using a set of product price levels and discount terms established for different contract parameters by the supplier. For the purposes of this application, the term “contract parameters” refers to features of the contract that the supplier may wish to associate with discounts to incentivize the buyer to comply with particular parameters or engage in a particular contracted behavior. For example, the supplier may offer discounts based on contract parameters such as contract duration, market share commitment, buyer spend volume, achievement of particular spend target(s) by a specific date(s) (e.g., an additional discount for spending $50,000 in a category within 6 months, or $100,000 within 12 months) or the like. The term “discount term” should be understood to relate to a particular discount level associated with performance according to a particular contract parameter. For example, a discount term of “5%” might be associated with a contract duration parameter of 24 months, or a discount term of “10%” might be associated with a market share parameter of “40% market share”. These discounts may, for example, take the form of a uniform discount applied to all products that are described within the pricing model (e.g., a discount percentage based on a spread between a minimum price and a maximum price), or a floor on an absolute discount (e.g., no more than a certain percentage off a list price). In circumstances where the discount represents a floor on an absolute discount, a single discount term may be used per pricing model (e.g., a maximum discount of 15%). These discount terms may be applied to a set of product price data to provide the buyer with a price response, including based on the discount terms from within the price model and a set of product prices. The price response may provide the buyer with information sufficient to enable the buyer to observe the impact on product prices as the contract parameters are altered by the buyer. The supplier may also establish various sub-models, such as pricing exceptions from a default pricing model. For example, a supplier may establish a default set of prices for a category, with exceptions (e.g., additional discounts or lower prices) for buyers of a particular size or type of organization (e.g., non-profit, teaching hospital, etc.), or where there are sets of products in a category where the profit margins for the sets of products are different than the margin for the category as a whole.

In the context of the present application, a “pricing utility” may be employed to allow for input and generation of pricing models. These pricing models may establish discount terms for various products based on contract parameters. Pricing models may be used in conjunction with a set of product prices to generate price responses to RFPs prepared by a buyer. The pricing utility may provide this functionality, allowing the supplier to select a particular pricing model, a particular set of product prices, and a particular RFP to generate the pricing response. The pricing response may include an array representation of a set of prices for various products, where the axes of the array relate to different contract parameters. In this manner, the pricing response may shield the buyer from the original terms contained within the pricing model and minimum/maximum product prices, such that the buyer only sees the end prices resulting from application of the pricing model to the product prices, simplifying the process of viewing the price for each product.

The market platform may further provide an interface for management of compliance with commitments between the buyer and supplier. The ability to monitor buyer spend data allows the market platform to determine the market share the buyer is providing to the supplier for the particular product or product category that is the subject of a supply contract between the buyer and supplier. The market platform may report market share compliance to both the buyer and supplier, and measure and/or enforce contract provisions according to the market share commitment met by the buyer. The market platform may also allow for the buyer and supplier to agree to particular enforcement provisions, rewards, and penalties for individual contracts. Embodiments of the invention may thus function to determine a value for a particular set or subset of contract offers for contract agreements between a buyer and a seller. In this context, the term “value” may be understood to be any quantitative or qualitative term that may be the subject of an optimization process. For example, a value may be a one or more of a financial term (e.g., a product cost or set of product costs), a quality term (e.g., a set of products that meet particular quality standards), an efficacy term (e.g., a set of products that have certain performance characteristics), a simplicity term (e.g., minimization of a change from a current set of suppliers), or any other value, quality, or characteristic.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, and/or the like.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, an applications processor integrated circuit for an integrated circuit in a server, a network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to a transitory electromagnetic signal.

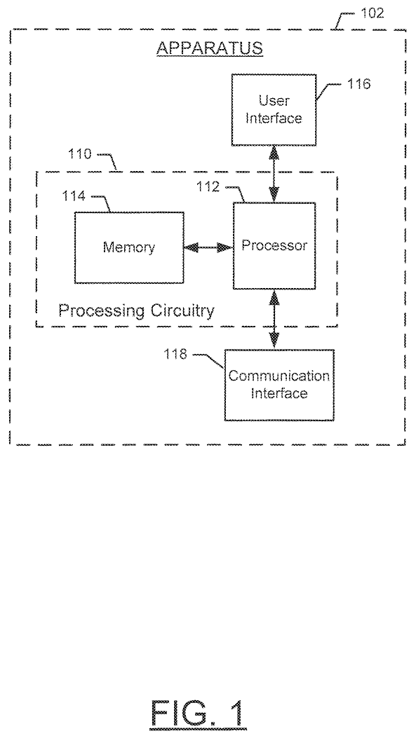

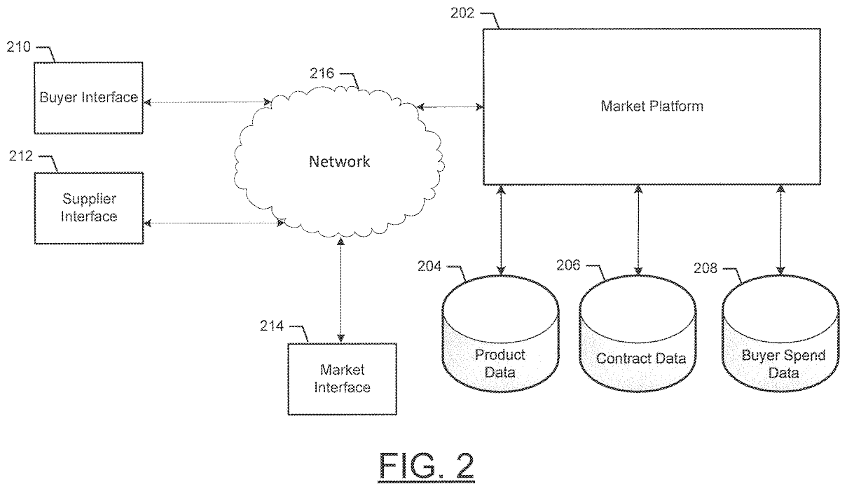

FIG. 1 illustrates a block diagram of an apparatus 102 in accordance with some example embodiments. The apparatus 102 may include a computing device that enables a market platform as described above. For example, the apparatus 102 may be implemented on one or more servers or other computing devices that may be configured to implement and control applications in accordance with various example embodiments. These applications may include hardware and software modules configured to receive market information, and to provide services related to the market platform as described above. As another example, the apparatus 102 may be implemented on one or more servers to provide a back-end interface and/or web interface in accordance with various example embodiments. Examples of computing devices that may correspond to the apparatus 102 are described further below with respect to FIG. 2. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA, or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 to carry out the functionality associated with each respective application. In some cases, the memory 114 may be in communication with one or more of the processor 112, user interface 116, and communication interface 118 via a bus(es) for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, and/or other input/output mechanisms. In embodiments in which the apparatus 102 is implemented on a server, aspects of the user interface 116 may be limited, or the user interface 116 may even be eliminated.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the Internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

FIG. 2 depicts a block diagram of a system 200 for managing purchase contracts in accordance with some example embodiments. The system 200 may include several computing nodes or devices in communication with one another. Each of the devices may have the same or similar configuration to the apparatus 102 described with respect to FIG. 1. The system 200 may include a market platform server 202 in communication with one or more of a buyer interface 210, a supplier interface 212, a market interface 214 and/or other devices (not pictured). The market platform server 202 may send and receive data to and from these devices 210-214 to facilitate management of a supply market.

The market platform server 202 may access one or more datastores. These datastores may include a product datastore 204, a contract datastore 206, and a buyer spend datastore 208. By accessing these datastores 204, 206, 208, the market platform server 202 may provide information to buyers and suppliers, manage contracts, and monitor compliance with said contracts for buyers and suppliers.

The product datastore 204 may include information describing products available from one or more suppliers. For example, in the medical field, HCOs may purchase tens of thousands of distinct medical and surgical supply products. These products may be purchased from hundreds or thousands of different suppliers. Such products may be organized into various categories relating to the type of product, the intended use of the product, or the like. For example, in the case of medical supplies and devices, products may be identified as belonging to a particular United Nations Standard Products and Services Code (UNSPSC). A category may be a pre-defined collection of one or more, and typically a plurality of, UNSPSCs. Categories may be pre-defined for a particular market ecosystem or may be pre-defined by the market. For example, products may be assigned to particular categories by the functionality of the product (e.g., products that protect the user from a particular hazard), by the construction of the product (e.g., products made of latex), by the intended use of the product (e.g., products used by surgeons during a heart surgery), general industrial knowledge, or by any other set of criteria. These categories may be established by an owner or maintainer of the market platform, or in communication with suppliers and/or buyers of the products. Product associations with particular categories may be mutually exclusive, such that any given product may only be associated with a single category. These categories may be further utilized to assist with a collection of buyer spend data, such that market share compliance may be based upon buyer spend in particular categories. Categories may include a plurality of related products and, in some embodiments, products may be associated with a single UNSPSC to assist with market share compliance measurements.

Product cross-references may be determined in a variety of ways (e.g., by user input, by supplier input where suppliers list products for which their products are equivalent, or the like), and there may be a variety of types of cross-references (e.g., exactly functionally equivalent for all uses, functionally equivalent for some uses). Although the cross-reference data stored in the product datastore 204 is described by example with respect to the medical supply field, the same techniques could be applied to other fields and industries, such as sports equipment, personal protective equipment (e.g., industrial gloves, masks, and aprons), manufacturing parts (e.g., auto parts), general contracting (e.g., nails, tools, lumber), school supplies, lab equipment, or the like.

The contract datastore 206 may include information pertaining to one or more contracts entered into by one or more buyer with one or more of the suppliers. These contracts may include products to be purchased, contract durations, item prices, and various compliance terms. The compliance terms may include various parameters, such as market share levels and associated prices. For example, a buyer may be entitled to purchase an item at a discounted price if they offer the supplier at least 80% market share of their spending in a particular product category (e.g., a particular UNSPSC). If the buyer only provides the supplier with 75% market share (e.g., the buyer purchases 200 items in the particular UNSPSC for a given compliance period, but only purchases 150 items from the particular supplier, or the buyer purchases $10,000 worth of product in a particular UNSPSC but only $7,500 from the particular supplier), the buyer may lose the discounted price, and the supplier may be entitled to recover the difference between the discounted price and the non-discounted price from the buyer, the supplier may be entitled to raise the price for the next compliance period, or other enforcement action may be taken, depending upon the contract parameters. The contract datastore 206 may also include price proposals offered by suppliers, but which are not accepted by the buyer. For example, the contract datastore 206 may store proposals created by the suppliers in response to a RFP generated by the buyer. As an alternative example of an over-compliance scenario, if the buyer were to purchase products equivalent to a 90% spend in a given market share, when the buyer only originally committed to an 80% category spend, the buyer might be presented with an additional discount for a next term, or a rebate equal to the difference between the discount level offered at an 80% market share versus the actual 90% market share.

The market platform server 202 may also be operable to receive spend data from a buyer spend datastore 208. In some embodiments, the buyer spend datastore 208 may be located at an external computing node from the market platform server 202. For example, the buyer spend datastore 208 may be implemented as a purchase order and invoicing or material management system used by the buyer to order products from one or more suppliers. The buyer spend datastore 208 may include an application programming interface (API) used to supply the spend data to the market platform server 202 as orders are placed or invoiced by the buyer. Although the buyer interface 210 and the buyer spend datastore 208 are represented as separate blocks in the illustration, these entities may also be implemented as a single entity, such as a computer node that provides both an interface to the market platform aspects of the market platform server 202 in addition to supplying the market platform server 202 with buyer spend data.

In some embodiments, the buyer spend datastore 208 may be an ERP system, and queries may be used to extract spend data from purchase orders. For example, Structured Query Language (SQL) queries may be performed at particular intervals (e.g., once a day, once a week, once a month), to extract item prices, quantities, model numbers, and the like, and report the extracted data as customer spend data. As alternative or additional examples, buyer spend data 208 may be provided to the market platform server 202 as a file periodically generated and/or extracted by a buyer. For example, a hospital may periodically generate a spend data file from invoice data. Such a file may be provided in a comma delimited format, such as a set of comma separated values (CSV) or a spreadsheet. As another additional or alternative embodiment, spend data may be placed in a particular storage location by the buyer (e.g., at a particular disk or network location), and periodically retrieved by the market platform server 202. The market platform server 202 may perform actions to normalize the data for generating analytics and/or benchmarks for the spend data across multiple buyers and/or suppliers. The market platform server 202 may also use the spend data to determine whether the buyer is meeting market share commitment levels (e.g., by comparing the total number of products purchased in a particular product category vs. the number of products in that category purchased from a particular supplier, or the total amount of spending in the particular category vs. the amount of spending with the particular supplier). Spend data may be tracked over a period of time, and beyond a particular month. For example, in some circumstances, buyer invoices may be reconciled beyond the month in which the purchase is invoiced, so spend data may be captured up to three months after the particular month, and invoices received during this time may be reconciled to the date in which the associated purchase was made.

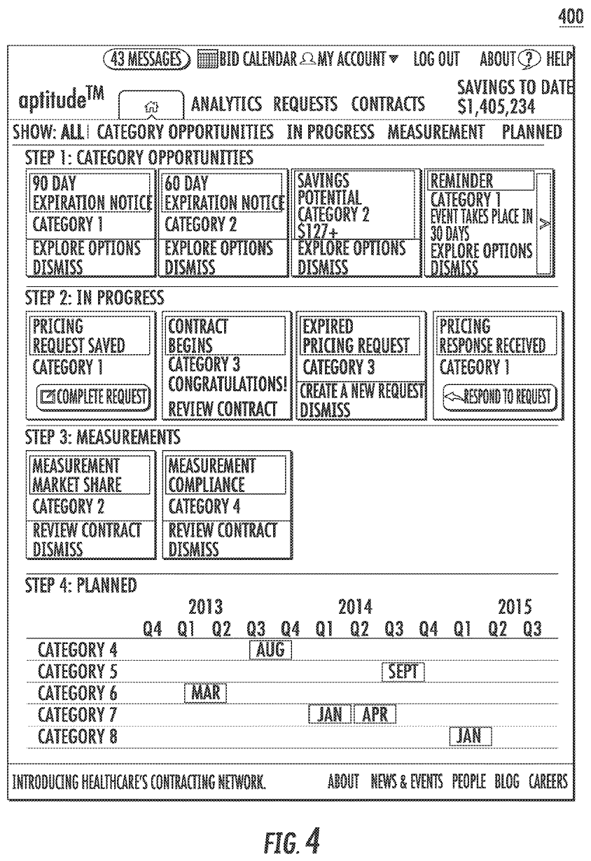

Buyers and suppliers may interact with the system 200 via a buyer interface 210 and a supplier interface 212, respectively. The buyer interface 210 may allow buyers to specify product supply needs to the market platform server 202, to review purchase plans generated by the market platform server 202, and enter into purchase contracts provided by suppliers. Contracts to which the buyer and supplier have agreed may be memorialized by the market platform as committed pricing agreements. These contracts may be generated by applying the terms of a particular pricing proposal to a template based on a set of rules, terms, and categories specified by the market platform. For example, prior to use of the market platform system, the buyer and supplier may each agree to certain base terms by which supply contracts generated by the system will be governed. When the buyer receives a response to a RFP, the price response may include a set of pricing terms. The buyer may make selections from these terms (e.g., market share commitment levels, contract duration, etc.), and apply these selections, along with pricing terms associated with said selections, to a committed pricing agreement template as defined within the previously agreed-to terms and conditions. The template with the terms from the pricing proposal applied may be used to generate a finalized committed pricing agreement containing contract language that includes the selected terms and associated prices. Buyers and suppliers may utilize e-signature technology to execute a committed pricing agreement generated by the system in this manner. The buyer interface 210 may also allow for viewing of analytics, benchmarks and compliance data derived from buyer spend data, so that buyers may monitor the status of their purchases and contracts. The buyer interface 210 may also enable buyers to create one or more RFPs to solicit pricing offers from suppliers. Examples of several screens and interfaces that may be provided by the buyer interface are provided below with respect to FIGS. 4-6 and 11-12.

The system may also include a market interface 214. The market interface 214 may provide administrative, management, and/or analytic services for interacting with the market platform. For example, the market interface 214 may provide access to analytic data generated by the market platform server 202 using the buyer spend data and contract information. The market interface 214 may provide an external or administrative user with access to various administrative and management functions, including but not limited to maintenance of user accounts and information, extraction of analytic data, generation of reports, or the like. In some embodiments, the market interface 214 may provide the ability to access analytic data to third parties external to the system.

In some embodiments, the buyer may utilize the buyer interface 210 to provide product cross-references to indicate similar or functionally equivalent products, and to rate and/or review products to notify other buyers of the performance of products they have used. The buyer interface 210 may include a login system that requires buyers to establish login credentials, ensuring that buyers only have access to their own data.

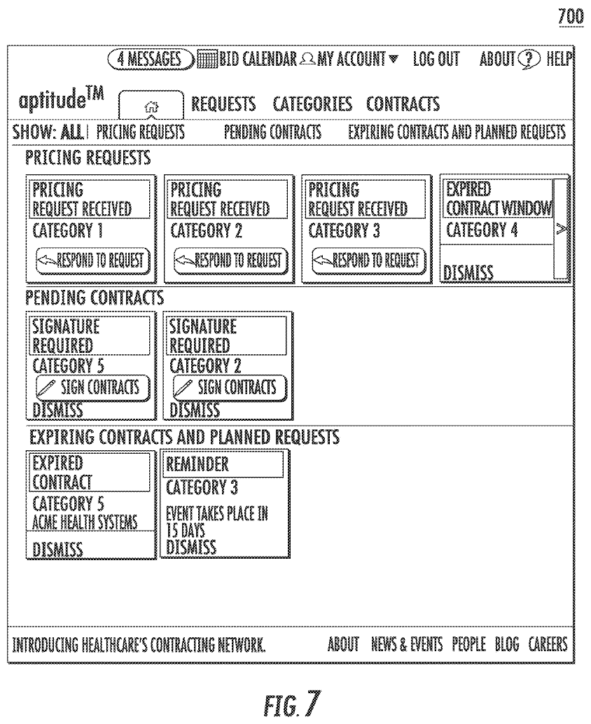

The supplier interface 212 may allow suppliers to provide data to the market platform server 202. Suppliers may provide information about their products, such as product names, product prices and/or pricing models. The suppliers may also use the supplier interface 212 to respond to RFPs initiated by buyers. RFP responses provided by the suppliers may include one or more pricing proposals for products related to the RFP (e.g., products identified by the buyer within the RFP, products associated with a category identified within the RFP, products associated with a category specified in the RFP and with the buyer's previous spending in the category, etc.), including contract parameters that are variable by one or more factors, such as the market-share example described above. The contracts may also include compliance provisions, payment provisions, penalties, and the like. Examples of several screens and interfaces that may be provided by the supplier interface 212 are described further below with respect to FIGS. 7-10 and 12.

The buyer interface 210, the supplier interface 212, and the datastores 204-208 may communicate with the market platform server 202 via a network 216. For example, the buyer interface 210 and the supplier interface 212 may be implemented as a web interface, accessible to buyers and suppliers via the Internet. As described above, the market platform server 202 may be configured to interface with a variety of computing devices located at the same or different nodes of the network 216.

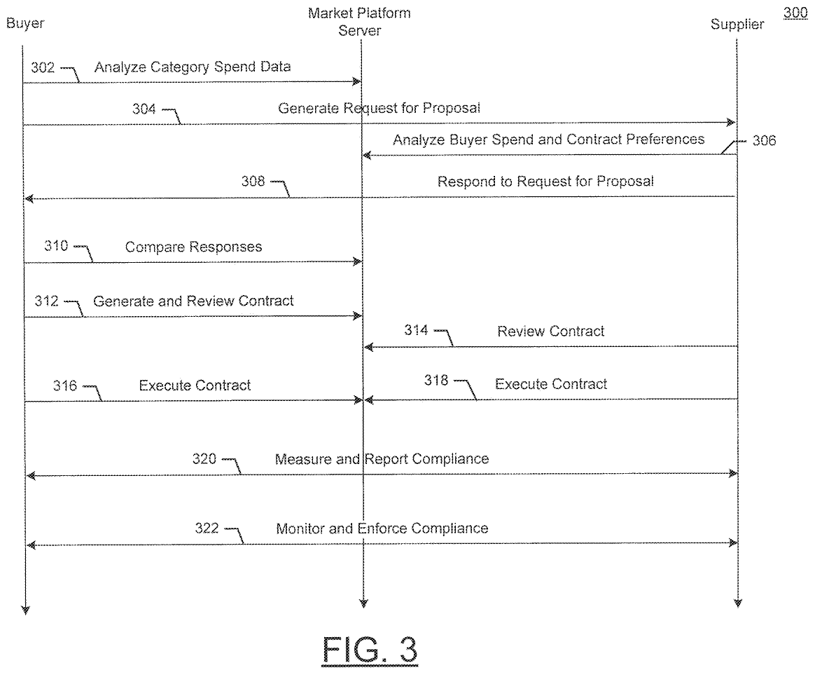

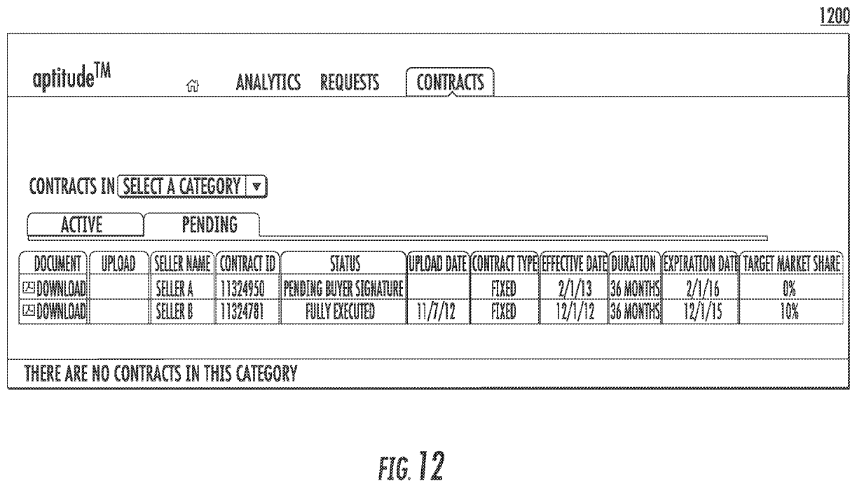

As described above the market platform server 202 may be operable to receive buyer product requirements in the form of one or more RFPs, to receive supplier price proposals in response to the RFPs, to generate a purchase plan for the buyer based on the supplier responses, to allow the buyer and supplier to enter into one or more contracts, and to determine compliance with the provisions of the entered contracts. Example methods for performing this functionality are described further below with respect to FIGS. 3 and 12.

FIG. 3 depicts a signaling diagram depicting messaging among a buyer, a supplier, and a market platform system in accordance with some example embodiments. The signal diagram 300 illustrates data flow among these entities throughout the market ecology established by the market platform system.

At action 302, the buyer provides spend data to the market platform system. The spend data may be associated with a particular category, such as with a particular UNSPSC in the category as described above. The buyer may provide their spend data to the market platform according to various formats. The buyer spend data may include product name, product identifiers and/or descriptions (e.g., Universal Product Codes, Universal Product Descriptions, supplier model numbers, stock keeping units), product manufacturers, equivalent products, market share commitment levels, and/or product volumes. In some embodiments, the buyer spend data may be provided in the form of one or more purchase order or invoices accessed and parsed by the market platform system. For example, the market platform system may communicate with a buyer ERP system to monitor and track invoices as products are purchased. For example, the buyer may provide a history of spend data (e.g., 3 months, 6 months, or 12 months of spend data) to the market platform, and the market platform may analyze the spend data to determine the parameters of the buyer needs. The market platform system may derive various analytics from the buyer spend data. For example, the market platform system may compare the buyer's spend data in a particular category against spend data for other buyers, or other buyers that share characteristics with the first buyer. This analytic data may be provided to the buyer to inform the buyer of where their product purchases in the particular category stand compared to all buyers and similar buyers. Such data may be useful to buyers to indicate particular products or categories that the buyer is spending more on or paying more than other buyers or other buyers with similar purchasing volume. This data may inform the buyer as to particular product categories for which the buyer may benefit from a price reduction or cost savings from soliciting proposals from suppliers to fulfill the buyer's needs in that category.

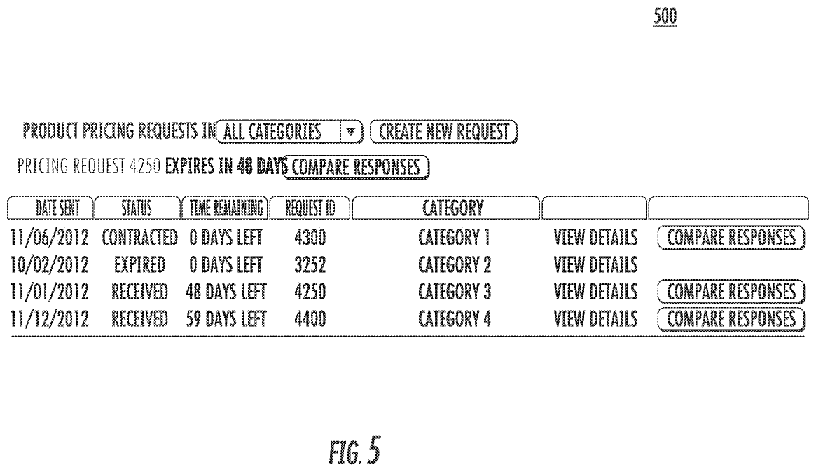

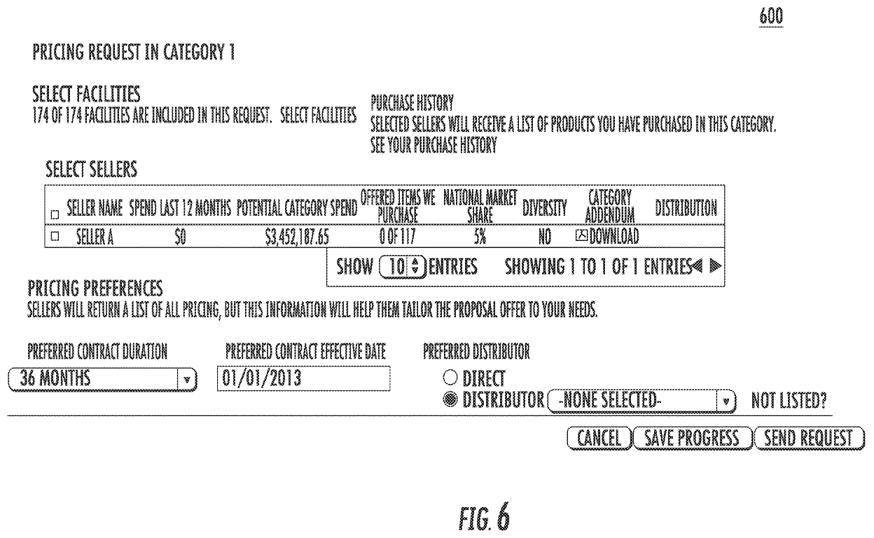

At action 304, the buyer generates an RFP and transmits the RFP to one or more suppliers via the market platform. As described above with respect to FIG. 2, the market platform may provide an interface by which the buyer can generate one or more RFPs for a particular category or categories and for a particular supplier or suppliers. The buyer may provide the market platform with the information necessary for generation of the RFP (e.g., product category, supplier name(s), buyer facility names), buyer contracting preferences (e.g., preferred duration, market share target, contract type, or the like) and the market platform may use the information to generate the RFP and notify the supplier. In some embodiments, the market platform may generate a notification to the supplier when the buyer creates the RFP, so that the supplier is aware of the RFP. The market platform may include a messaging interface to send a message to the supplier upon generation of the RFP, or the market platform may notify the supplier by additional or alternative means, such as by sending an e-mail to an address specified by the supplier. Example interfaces for generation of an RFP are described further below with respect to FIGS. 5 and 6.

At action 306, the supplier may examine the buyer's spend data and any contract preferences indicated in the RFP. For example, the supplier may be provided with data indicating the buyer's size, the buyer's historical spending in the particular product category, the buyer's desired contract duration, and/or any other factors that may be included in the RFP by the buyer. Examination of the buyer and the buyer's preferences in this manner allows for the supplier to make informed decisions about a pricing model or set of prices and a set of product prices to generate or include in a price response to be sent to the buyer, or in response to the RFP. For example, if the buyer is a large entity or has a large amount of spending in the particular category of the RFP, then the supplier may be more inclined to offer a larger discount owing to the likely high volume of sales. Alternatively, the supplier may choose to be less flexible on price if the buyer is a smaller client.

At action 308, the supplier may respond to the buyer's RFP with a pricing proposal. The pricing proposal may include one or more prices for products in the category of goods requested by the buyer. These prices may be related to certain compliance terms. For example, prices may be based on buyer market share commitments, such that the greater the market share commitment offered by the buyer, the greater the discount offered by the supplier. Various other compliance terms may be included in the pricing proposal offered by the supplier. For example, the supplier may offer discounts based on contract durations or particular types of measurement and/or enforcement mechanisms. In some embodiments, the supplier specifies a maximum and minimum price for each product, with discounts offered within the maximum and minimum range. Discounts between the maximum and minimum range may be assigned evenly between the maximum or minimum, or according to various other methods. For example, the supplier may be presented with the option to select a line or curve for defining discount levels between the maximum and minimum, such that the slope of the line or curve determines the rate at which the discount values increase or decrease.

At action 310, the buyer may compare responses provided by one or more of the suppliers. The market platform may provide tools for the buyer to perform this comparison. For example, the market platform may offer a graphic representation of prices at different market share levels to assist the buyer with selection of one or more of the proposals offered by the suppliers. The market platform may further offer tools for optimization of multiple contracts, or multiple contract term selections for a single contract, to assist the buyer with obtaining an optimal contract mix for the buyer's specific needs. For example, a first buyer may wish to focus on controlling costs as much as possible, even if controlling costs means accepting the inconvenience of many supplier contracts. This first buyer may instruct the market platform to identify a mix of proposals that offers the lowest aggregate costs. A second buyer may prefer to minimize the inconvenience of dealing with multiple suppliers, and may instead prefer a supplier mix that obtains as many products as possible from a single supplier. This second buyer may instruct the market platform to optimize a contract mix to minimize the number of suppliers. The market platform may offer various other tools and applications for assisting the buyer with comparing the proposals offered by the suppliers.

At action 312, the buyer may select one or more of the proposals offered by the supplier, and indicate to the market platform that the buyer wishes to accept the selected proposal. The market platform may thus initiate a contract between the buyer and the suppliers of the selected proposals based on the terms of the selected proposals. For example, the market platform may generate a document (e.g., a portal document format (PDF) file) for acceptance by the buyer and supplier, and notify the supplier that the buyer has accepted the proposal. The buyer may review this contract prior to final selection of the proposal, or the buyer may review the contract simultaneously with the supplier. At action 314, the supplier is notified of the accepted proposal and given the opportunity to review the contract.

At actions 316 and 318, the buyer and supplier each execute the contract. Execution of the contract may be performed electronically using the market platform, or the buyer and supplier may each indicate to the market platform when they have formally executed the contract. For example, the buyer and supplier may execute the contract in person or via traditional mail, and each indicate to the market platform when they have executed the contract. In response to receiving an indication of acceptance from both the buyer and supplier, the market platform may mark the contract as accepted and memorialize the accepted contract using the market platform. For example, a copy of the executed agreement may be scanned into the system.

At action 320, the market platform measures the performance of both the buyer and supplier, and monitors and/or enforces compliance with the terms of the contract. Measurement may be performed by continued monitoring of the buyer spend data, to determine if the buyer is meeting or exceeding the agreed upon market share commitment levels. In some embodiments, the market platform may inform buyers and suppliers of compliance levels, and allow the buyers and suppliers to determine on their own if terms of the agreement should be enforced.

At action 322, alternatively or additionally, the market platform may provide for enforcement measures. For example, enforcement may relate to measuring that the supplier is meeting their commitment to supply the buyer with goods in a timely manner according to the buyer's needs. Ongoing monitoring and enforcement may include adjusting product price levels in response to changes in the market share commitment levels met by the buyer, offering a rebate to the buyer if they exceed their market share commitment agreement, or other enforcement measures. This monitoring and/or enforcement may be performed at particular intervals, such as every 3 months, every 6 months, or every year. For example, the system may provide ongoing performance measurement for viewing by the buyers and suppliers, with particular quarterly milestones to report current compliance and allow the parties to take appropriate measures based on the compliance status.

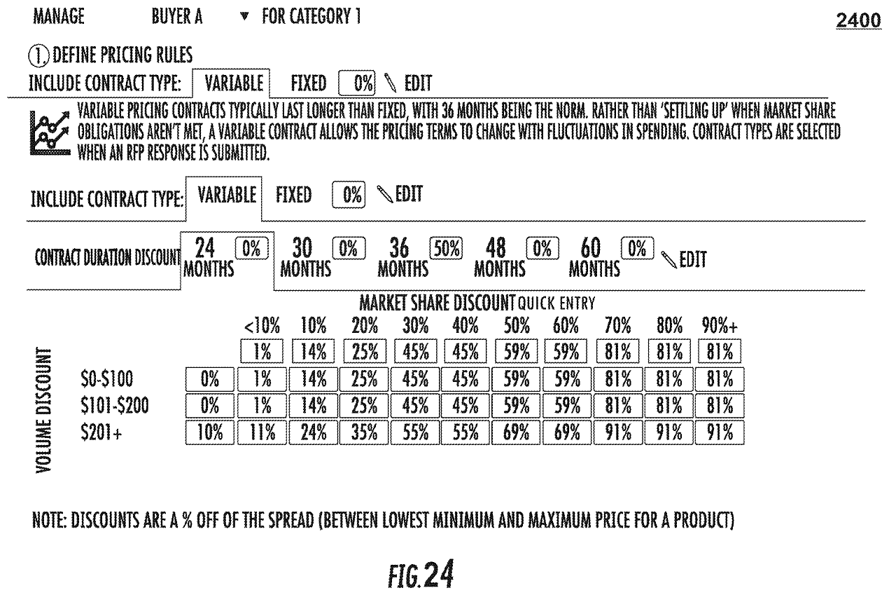

To assist the supplier with responding to buyer RFPs, the market platform may offer various tools and techniques for generating product pricing data for consideration by the buyer. These tools may include a multi-dimensional array representation of discount levels for products within a category, with market share commitment levels, sales volume numbers, contract durations, contract types, and/or other contract parameters along axes of the multi-dimensional array. These tools may also provide for further interface options for viewing and altering contract parameters, such as tabs associated with a two dimensional grid of prices. Particular pricing models may be established for each product in a category or the category as a whole, and these pricing models may be provided in a format that allows for saving, loading, re-using, and copying of price information to simplify the process of responding to an RFP. Pricing exceptions may also be established to these price models. For example, these exceptions may operate as “sub models” that only modify certain terms of the price model. As an example, a supplier may wish to offer an additional discount on certain products for a certain buyer or type of buyer. The supplier may thus establish an exception for certain products within the category associated with the price model that will only be applied for the particular buyer the supplier designates. Pricing models and exceptions may also be associated with particular buyers or buyers of a particular size, or other buyer characteristics, to prevent the supplier from having to recreate the entire pricing model from scratch for every RFP. Example interfaces and methods for generating pricing models are described further below with respect to FIGS. 24-28.

The market platform may store data relating to purchase plans and pricing responses derived for buyers from one or more contract offerings provided by the suppliers. The market platform may provide a purchase planner for interacting with this data. The purchase planner may enable a buyer to view proposals offered by multiple suppliers and to examine different mix scenarios to identify an optimal set of proposals to meet the buyer's needs from the available proposals. The purchase planner may allow for the buyer to alter market share commitments and contract durations to determine the impact of the alterations on the buyer's overall purchasing. As the buyer changes commitment levels for a first proposal, the purchase planner may ensure that the buyer does not exceed 100% category market share commitment by adjusting other selected proposals as needed. The category market share commitment may be determined based on the supplier's maximum potential market share in the category, rather than the overall market share for the category. For example, a supplier may not offer a particular product or product cross-reference for an item in a category purchased by the buyer. Purchases of this product which the supplier does not offer would not be used to calculate the market share provided by the buyer in such a scenario. As such, buyer market share calculations may not be affected where suppliers provide different levels of coverage in a category. This also means that two or more contracts in a given category may be able to reach market share commitments that exceed 100% in aggregate, as different suppliers may not have overlapping coverage in the same category, such that purchasing a product from a first supplier does not reduce the market share of a second supplier. The purchase planner may also allow the buyer to “lock” certain proposals such that alteration of other proposals does not impact the locked proposals. The purchase planner may also allow the buyer to optimize for different contract mixes and to see the proposals that result in these optimal mixes. For example, the buyer may optimize for a maximum cost savings, minimum product conversion, a minimum number of suppliers, or various other contract mixes.

The market platform may include various applications, interfaces, and methods for enforcing compliance with the terms of contracts entered into between buyers and suppliers. These contract terms may relate to market share commitment levels, contract durations, other contract terms and conditions, enforcement terms and conditions, and the like. By reviewing and analyzing buyer spend data, the market platform may accurately determine whether both parties are meeting their obligations under the agreed-upon contracts. In the event that one or both parties are not in compliance (or in over compliance), the market platform may dynamically enforce the terms of the contract as specified in the original agreement.

For example, in a scenario where the buyer is not meeting an agreed-upon market share commitment for product purchases within a particular category, the market platform may notify the supplier of the under compliance, and provide the supplier with various options as specified under the original contract. These terms may include adjusting the price of the products for the next compliance period, requesting a payment from the buyer in the amount of the discount level that the buyer failed to meet, or various other contract measurement and/or enforcement methods. By ensuring compliance with the terms of the contract, the market platform advantageously provides suppliers with accurate data about compliance. Because suppliers are provided with accurate compliance data, the suppliers do not need to budget for possible unverifiable under compliance by the buyer, nor do the suppliers need to conduct audits to verify compliance. As such, suppliers may offer buyers lower prices or price rebates due to the accurate reporting of data.

FIG. 4 depicts a screen capture of a buyer dashboard interface 400 in accordance with some example embodiments. The buyer dashboard interface 400 provides a landing page for the buyer upon accessing the market platform. The buyer dashboard interface 400 may include one or more notifications to the buyer. For example, the buyer dashboard interface 400 as depicted in FIG. 4 shows several notifications to the buyer, such as contracts that are near the end of their term, ongoing contracts, the status of RFPs generated by the buyer, and upcoming events to be considered by the buyer.

FIG. 5 depicts a screen capture of a buyer RFP review interface 500 in accordance with some example embodiments. The buyer RFP review interface 500 may provide a buyer with a view of outstanding RFPs, and responses received to the RFPs. In this manner, the market platform may provide the buyer with a single interface for managing ongoing RFPs and to view the responses to each RFP. The RFP review interface 500 may further include an interface element that, when selected, initiates a new RFP from the buyer to one or more suppliers.

FIG. 6 depicts a screen capture of a buyer RFP generation interface 600 in accordance with some example embodiments. The buyer RFP generation interface 600 provides an interface that allows a buyer to enter contract parameters and discount terms for an RFP. The buyer may specify a particular product category, one or more suppliers, and preferred contract settings. The buyer RFP generation interface 600 may also provide seller profile data on suppliers selected by the buyer, such as indicating the supplier's total market share in the category, the supplier's total sales in the category, if the supplier meets minimum diversity standards, how many of the supplier's offered items are purchased by the buyer based on buyer spend data, the number of employees of the supplier, and the like. The buyer may select particular sellers to whom to issue RFPs based on these seller profile characteristics. For example, the buyer may solicit proposals from suppliers of below a certain number of employees, or suppliers that meet certain diversity standards.

FIG. 7 depicts a screen capture of a supplier dashboard interface 700 in accordance with some example embodiments. As with the buyer dashboard interface 400, the supplier dashboard interface 700 depicts a top level interface for providing notifications to the supplier. In the instant example, the supplier is provided with notifications of incoming RFPs for various product categories, notifications of contract proposals that have been accepted by buyers and that are awaiting signature by the supplier, and notifications of expired contracts and upcoming contract expirations.

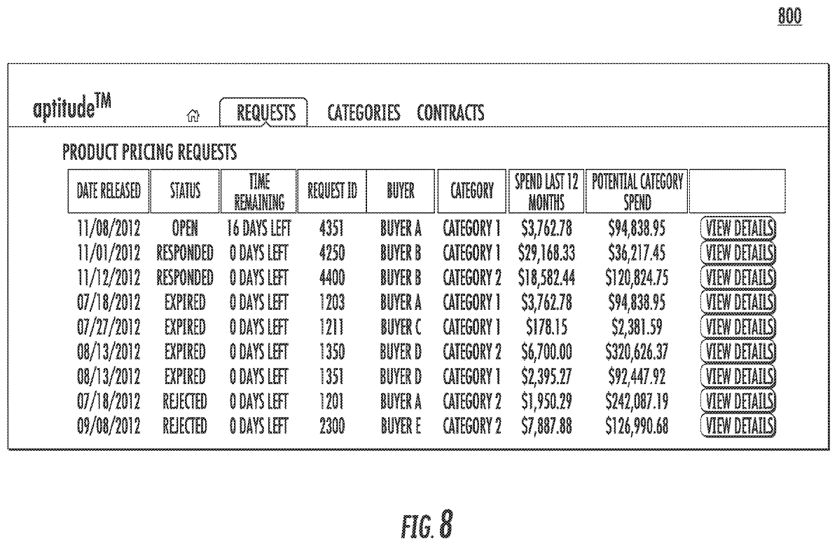

FIG. 8 depicts a screen capture of a supplier RFP review interface 800 in accordance with some example embodiments. The supplier RFP review interface 800 depicts incoming RFPs received from buyers. The supplier RFP review interface 800 thus allows for selection of particular RFPs so that the supplier may prepare a response to the RFP. The supplier RFP review interface 800 may also provide data about each buyer at a glance, such as the date the RFP was received, the date the RFP expires, the buyer's expected spend in the relevant product category, the status of each RFP, and the buyer's potential spend in the relevant product category if the buyer were to purchase all of the category's products from the supplier.

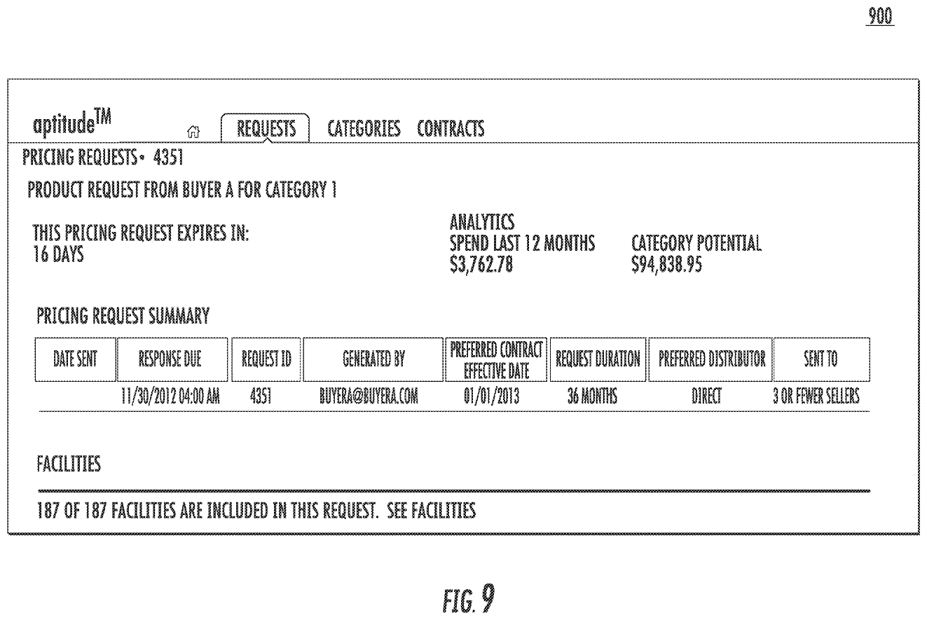

FIG. 9 depicts a screen capture of a supplier RFP detail view interface 900 in accordance with some example embodiments. The RFP detail view interface 900 may provide the supplier with in-depth data for a selected RFP, such as which of the buyer's facilities are included in the RFP, the identity of the buyer's point of contact in charge of the RFP, the buyer's preferred contract duration, and the number of suppliers involved in the RFP. The RFP detail view interface 900 may also provide an interface control allowing the supplier to craft a response to the RFP.

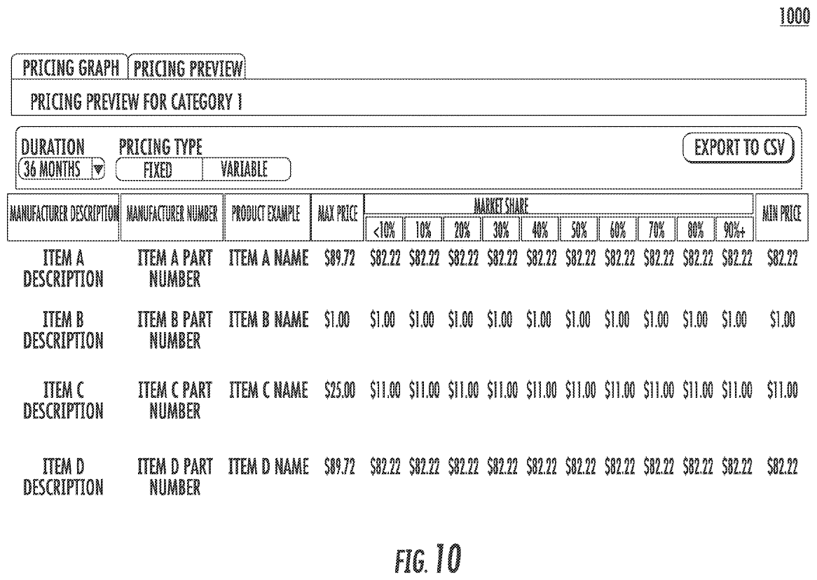

FIG. 10 depicts a screen capture of a supplier RFP response interface 1000 in accordance with some example embodiments. The supplier RFP response interface 1000 provides the supplier with a display of a pricing proposal that will be sent to a buyer in response to an RFP. The supplier RFP response interface 1000 may depict prices for one or more products in the category of the RFP, along with price discounts afforded due to conditions of the RFP, such as buyer market share commitments. The supplier may be able to alter various elements of the display to affect the response provided to the buyer, such as altering the base price of the product or the maximum product discount.

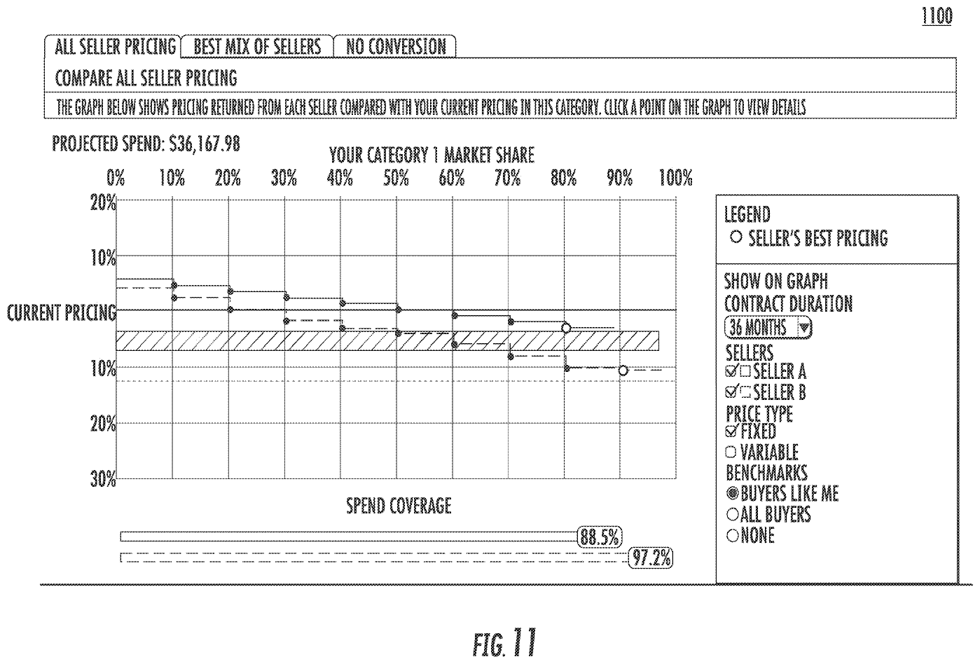

FIG. 11 depicts a screen capture of a RFP response review interface 1100 in accordance with some example embodiments. The RFP response review interface 1100 provides the buyer with a graphical display of supplier RFP responses to assist the buyer with selection of one or more of the proposals. The RFP response review interface 1100 may include visual interface elements, such as a graph of each proposal across various market share levels. The RFP response review interface 1100 may further allow for the buyer to view the proposed prices in relation to market price levels among all customers, or among customers with similar profiles (e.g., size, volume, type of buyer) as the buyer. The buyer may select different models for viewing of the optimal proposals. For example, a first view may highlight proposals that minimize overall cost, a second view may highlight a mix of proposals that provide the best mix across all suppliers, and a third view may highlight a set of proposals that avoid converting to new suppliers.

FIG. 12 depicts a contract status interface 1200 in accordance with some example embodiments. The contract status interface 1200 provides a status overview of contracts available or accepted by the party viewing the contract status interface 1200. For example, a buyer may view contracts that the buyer has previously accepted, and contracts the buyer has sent to suppliers for review in response to selection of a price proposal from an RFP response. A supplier may view contracts accepted by the supplier and contracts sent by the buyer for review and acceptance by the supplier. Each accepted contract may be associated with an interface element allowing the buyer or supplier to view the compliance status of the contract, based on spend data received from the buyer.

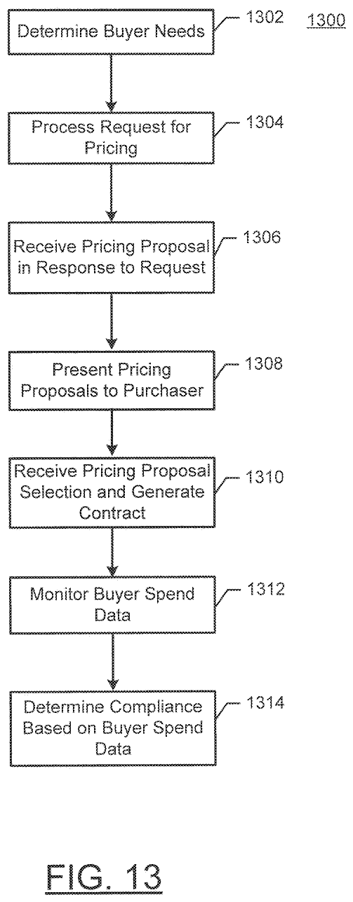

FIG. 13 depicts a flow diagram of an example method 1300 for implementing a market platform in accordance with some example embodiments. The method 1300 is an example of a process performed by a market platform, such as the market platform server 202, to assist buyers with requesting and selecting one or more contract proposals provided by one or more suppliers, and to assist suppliers with monitoring and enforcement of contract provisions, such as market share commitments.

At action 1302, the method receives a set of buyer needs. As described above, the buyer needs may be derived from a set of spend data provided by the buyer (e.g., 3 months, 6 months, or 12 months of spend data), or the buyer may manually generate a RFP to request pricing for a particular product, product category, or group of products/product categories. These needs may be identified based on purchasing efficiency analytics and benchmarks, examination of a contract bid calendar, identification of expiring contracts, or the like.

At action 1304, a RFP may be generated by the method in response to input received form the buyer at action 1302. The RFP may be provided to one or more suppliers to allow the suppliers to generate pricing proposals in response to the RFP.

At action 1306, the method 1300 may receive pricing information, such as contract parameters, in response to the RFP generated at action 1304. As described above with respect to FIG. 3, suppliers may present one or more pricing proposals to meet some or all of the needs of the buyer, and the market platform may analyze these pricing proposals to generate a purchase plan for the buyer.

At action 1308, the method 1300 may present the pricing options (e.g., a series of contracts with buyer's options one or more parameters) received from the suppliers to the buyer. The pricing options may be presented as a series of pricing proposals with different contract parameters and/or discount terms, or, as described above, the user may be presented with a purchase plan that provides a selection of optimal contracts or sets of one or more contracts for the user. Upon acceptance of one of these pricing proposals by a buyer, a contract may be generated from the terms of the pricing proposal.

At action 1310, the method 1300 may receive a selection of pricing options from the buyer. As described with respect to FIG. 3, the market platform may generate a contract or other committed pricing agreement from the selection. This selection may indicate that a contractual relationship has been entered into between the buyer and supplier at the terms specified in the selected contract.

At action 1312, the method 1300 may monitor buyer spend data to track compliance with the terms of the selected contract. In cases where compliance is based on market share, the method 1300 may determine market share levels by comparing the purchases of the product from each supplier with the total purchases of products in that product category from all suppliers. At action 1314, the data derived from the spend data (e.g., market share levels) may be compared against the terms of the contract to determine if the buyer is in compliance. In circumstances where the buyer is not in compliance, the market platform may notify the supplier to take appropriate action, or the market platform may automatically enforce the terms of the contract (e.g., by raising the price of the products, or by imposing a penalty on the buyer to be paid to the supplier in the amount of the contract deficiency).

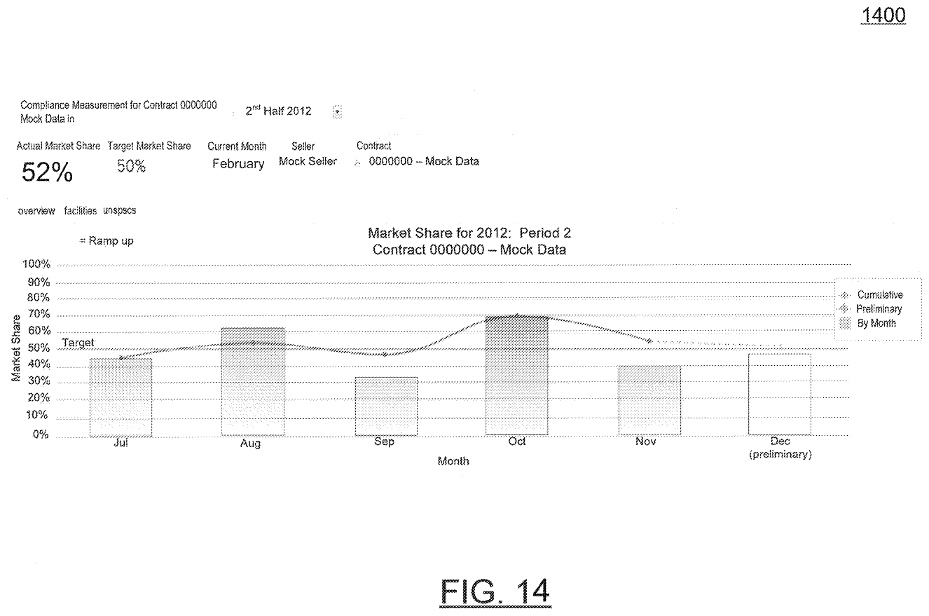

FIG. 14 depicts a screen capture of an example interface 1400 for monitoring contract compliance in accordance with example embodiments of the present invention. The interface 1400 allows for buyers and suppliers to view a graphical representation of the current compliance status. The image depicts a series of bars representing market share performance levels reached by the buyer over a series of compliance periods, such as over several months. A target commitment level is represented as a horizontal line at the commitment level target established during negotiation between the buyer and supplier. The interface further depicts an expected compliance level for upcoming review periods, and a cumulative compliance level that shows the overall compliance in aggregate. Individual values depict the current compliance level, the target commitment level, the current month, the seller, and various other parameters of a particular pricing agreement.

Although the compliance periods illustrated in FIG. 14 are related to particular months, such data may be aggregated over a longer period of time. For example, invoices and product orders placed in a particular month may not be fulfilled until a later time, and thus accurate tracking of performance may not be possible until fulfillment has occurred, even though the actual compliance occurs during the compliance period. As such, a sliding window for compliance periods may be established, such that compliance is measured for a certain period after the actual dates of the compliance period. For example, compliance for January may not be available until April, to allow for a two month window for any purchase orders or invoices prepared in January to be fulfilled. Furthermore, when initiating a new pricing agreement, it may not be practical to expect a buyer to perform according to their full market share commitment immediately. Contracts may thus include a ramp-up period for compliance measurement, such that enforcement and full monitoring is not enabled until the buyer and supplier have established a certain time period or number of transactions. The interface 1400 may provide a graphical representation of this ramp-up period, such as by cross-hatching compliance measurement bars during the ramp-up period. Compliance may be measured and reported in real-time, or at particular intervals. By measuring compliance in real-time, buyers and suppliers may be presented with accurate, real-time data that allows for ongoing adjustment to purchasing habits in order to meet with compliance goals.

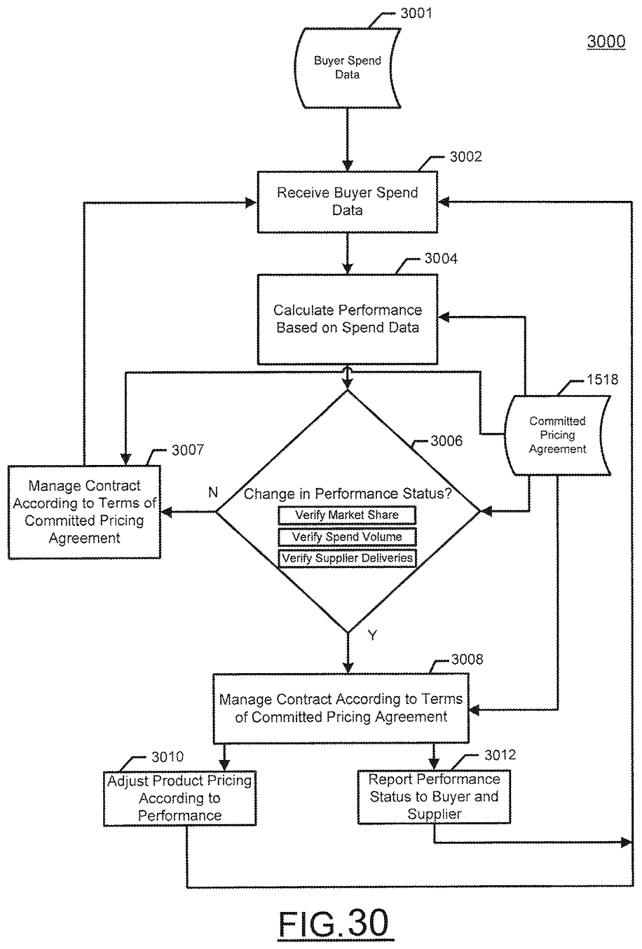

FIG. 30 depicts a flow diagram illustrating an example method 3000 for providing contract compliance monitoring in accordance with some example embodiments of the present invention. The method 3000 enables a buyer and a supplier to monitor the achievement of both parties based on the spend history of the buyer and according to a previously negotiated committed pricing agreement 1518. The buyer and supplier may thus adjust price levels for underachievement or over achievement by one or both parties to conform to agreed pricing terms. The method 3000 may allow for adjustment of price levels or various terms to be enforced automatically by a computer system, such as a market platform server, or the method 3000 may function to inform the buyer and supplier of compliance and allow the parties to determine how to proceed. For example, if a buyer agrees to a first price at a first market share commitment level, and the buyer exceeds that first market share commitment level to reach a second, higher market share commitment level, the method 3000 may adjust pricing of products sold under the agreement to a discount level associated with the second market share commitment level. The method 3000 may be performed by a market platform, such as the market platform 202 described with respect to FIG. 2.

At action 3002, the method 3000 receives buyer spend data from a buyer spend data source 3001. As described above, the buyer spend data 3001 may be received by analysis of buyer invoice and/or purchase order data, recall alerts from a supplier, from a buyer ERP or materials management system, by extracting data from one or more files provided by the buyer, or the like (see FIG. 2). At action 3004, achievement, such as a market share commitment level reached by the buyer, is determined from the buyer spend data. For example, the buyer spend data may be analyzed to determine the total buyer spend for items in a product category available from the supplier, compared to the total amount the buyer could have spent in the category if the buyer did not buy products from other suppliers. As another example, the buyer spend data may be analyzed to determine the total volume of product sales the buyer purchased from the supplier within the category.

At action 3006, a determination is made as to whether there has been a change in achievement status based on the analysis of the spend data at action 3004. As described above and as depicted in FIG. 14, a compliance target commitment level may be associated with the committed pricing agreement 1518. This compliance target commitment level may reflect the previous achievement levels of the parties (e.g., the sales volume for the previous review period), or an initial commitment level (e.g., a commitment level negotiated upon execution of the agreement). Action 3006 may include verifying whether this status has changed. For example, the method 3000 may determine whether the current achievement levels indicate a change in market share, sales volume, or supplier deliveries that would cause a change in the status of the agreement. For example, if the buyer has met but not exceeded a market share commitment level, then no action may be taken by the buyer or supplier. However, if the buyer has exceeded the market share commitment level, then it may be appropriate to offer a benefit to the buyer (e.g., a larger discount), or if the buyer has not met a target market share, then the buyer may receive a penalty (e.g., payment to the supplier of the difference between the discount for the actual market share reached and the discount for the original commitment level). If the achievement is consistent with the previous compliance target commitment level, then the method proceeds to action 3007 to manage the contract according to the terms of the contract consistent with ongoing compliance with the contract. Otherwise, the method proceeds to action 3008 to provide enforcement consistent with the terms of the contract where performance has changed.

At action 3007, if the terms of the contract specify some action to take place in response to no change in the performance status (e.g., a buyer meets but does not exceed an agreed upon performance level), certain actions may be taken. For example, the buyer may receive a benefit for meeting their current performance commitment, such as a rebate offered in a rebate contract model. The method may return to action 3002 to continue monitoring of performance after managing the contract.

At action 3008, the contract is managed according to the terms of the agreement in view of the change in performance status detected at action 3006. These terms may be defined within the committed pricing agreement 15818. For example, the committed pricing agreement's management terms may describe measures to be taken in response to a change in compliance target commitment level achievement status. These management terms may, for example, ensure that the market platform informs both the buyer and the supplier of the compliance target commitment level of the agreement in the event of under achievement or over achievement. For example, the market platform may send an e-mail to the buyer and supplier with the compliance target of each party. The buyer and supplier may thus optionally take appropriate action. For example, a supplier may elect not to enforce a price increase for a good customer that regularly meets market share commitment levels, but has a single lapse.

Alternatively, the method 3000 may provide for automatic enforcement of contract provisions. For example, contracts may include a set of variable terms that adjust based on buyer and supplier achievement. As these variables change, so too do elements of the contract. One example is where prices are provided according to a pricing array, where axes of the array are related to different variables such as sales volume or market share. As these variables adjust, the buyer is offered discount levels consistent with the variable values. In embodiments where the market platform is configured to automatically enforce the terms of the contract, these prices may dynamically update as the achievement of the parties changes. For example, different contract models may have different enforcement provisions, such that a variable price contract may update a price for the next contract period in response to under or over achievement, while an escrow contract may refund a difference between a standard price and a discount price when the buyer is compliant with the terms of the contract. As such, while action 3008 is described as occurring in response to a determination that achievement is not consistent with the compliance target commitment levels, contract enforcement could alternatively take place in response to achievement that meets or is otherwise consistent with predetermined commitment levels.

Actions 3010, and 3012, describe example actions that may be taken to manage the contract. For example, at action 3010, pricing terms may be adjusted for the contract according to the established achievement levels and a pricing array associated with the committed pricing agreement 1518. At action 3012, the buyer and supplier may be notified of the contract status so that they may take appropriate action. After taking appropriate action to manage the contract in view of the achievement, the method 3000 may return to action 3002 to continue receiving buyer spend data to manage the contract.

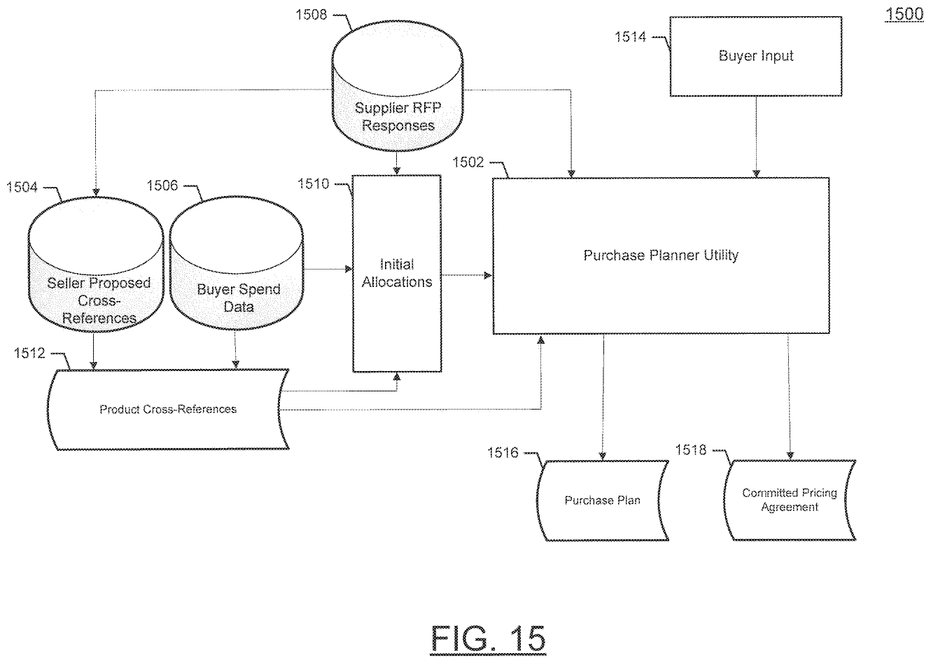

FIG. 15 depicts a block diagram of a purchase planning system 1500 in accordance with some example embodiments. As described above with respect to FIG. 2, a market platform may be operable to provide buyers with the ability to generate a purchase plan that reflects product selections, market share allocations for product selections, discount levels, and estimated spending in accordance with pricing proposals received from one or more suppliers. The purchase planning system 1500 depicts an example system for generating these purchase plans. The purchase planning system 1500 may include a purchase planner utility 1502 that generates a purchase plan 1516 and/or a committed pricing agreement 1518 using a buyer spend data 1506, seller RFP responses 1508, and user input 1514. The purchase planning system 1500 may be implemented by or executed on, for example, a market platform server, such as the market platform server 202 described with respect to FIG. 2.

The purchase planner utility 1502 may exist as a combination of hardware and/or software executing on a computing device. The purchase planner utility 1502 operates to determine a set of product selections, market share allocations within the product selections and contract commitment values to optimize spending for a buyer for a particular product, particular set of products, a product category, or a set of product categories.

Generation of the purchase plan 1516 may include analysis of one or more supplier RFP responses 1508. These supplier RFP responses 1508 may be received in response to a RFP generated by the buyer, as described above with respect to FIGS. 2-14. The RFP responses 1508 may include a list of products offered by the seller, and set of prices for those products according to various contract performance levels (e.g., market share commitments, sales volumes, contract durations). For example, a buyer may identify a particular product category for the RFP, and indicate to the supplier all of the products the buyer has previously purchased in that category according to the buyer's previous spending. The supplier may respond to the RFP with an RFP response that indicates which of the supplier's products are valid cross-references for the products identified by the buyer in the RFP.

A set of seller proposed cross-references 1504 may be stated in the supplier RFP responses 1508, or these seller proposed cross-references 1504 may be received directly from the supplier. For example, a supplier may provide the market platform with a list of all of their products, along with a list of which competitor products currently purchased by the buyer they believe are valid cross-references. Additionally or alternatively, such information may be provided with the seller RFP responses, or the seller RFP responses may identify particular products as cross-references based on the request submitted by the buyer. For example, in generation of the RFP, the buyer may indicate that their previous spending in the category related to three particular products, and the seller may respond in the RFP response by indicating which of their products they believe will serve as cross-references to the three products requested by the buyer.

The system 1500 may also include a set of buyer spend data 1506, such as the buyer spend data 208 described above with respect to FIG. 2. The buyer spend data 1506 may include historical spending data received from the buyer that is generating the purchase plan, other buyers that utilize the market platform for purchasing, and/or any other buyer spend data. This buyer spend data 1506 and product selections derived from purchase plans generated by other buyers may be analyzed to determine which products buyers generally select as cross-references. For example, the buyer spend data 1506 may track that, when buyers are presented with a choice between two particular products for inclusion in a purchase plan, buyers generally choose one or the other. The more frequently chosen product may be identified as a “crowd-sourced” or “community” cross-reference. In this manner, cross-references may be dynamically generated by the system 1500. Additional cross-reference types may include secondary supplier cross-references, where sellers provide additional cross-reference products for a given source product aside from their primary or “suggested” cross-reference product, highest rated cross references which are based on explicit user ratings and lowest cost cross-references, showing the lowest-cost cross-reference across all suppliers.

The system 1500 may thus generate a list of product cross-references 1512. These product cross-references may include all valid cross-references for a particular pricing response or set of pricing responses, or the list of product cross-references 1512 may be a global list that is equally applicable across all potential purchase plans.

The buyer spend data 1506 may also be used to derive a set of initial allocations 1510. The initial allocations may include the buyer's current product selections, supplier selections, and product purchase allocations. These initial allocations may be used as a baseline to provide a starting point for generating the purchase plan. For example, these allocations may be derived from the buyer's current spending on the products associated with the RFP, and the initial allocations may reflect the buyer's product selections, sales volume, and product purchase allocations. The product purchase allocations may reflect which products the buyer intends to purchase to meet the need for a particular product identified in the RFP, or in the product category identified in the RFP. For example, a buyer may have a need for latex gloves, and several suppliers may offer gloves that are valid cross-references for the type of gloves the buyer was previously purchasing. The buyer may allocate their spending across all three suppliers, with 20% of their spending related to latex gloves from Supplier A, 30% of their spending related to latex gloves from Supplier B, and 50% of their spending related to latex gloves from Supplier C. In some embodiments, the total allocation values represent a percentage of a previous spending for a particular product. For example, if a buyer knows that they are likely to have a greater need for the particular product, the buyer may provide product allocations that total greater than 100%, reflecting an increase in purchasing of the product over the previous measurement period. Conversely, if the buyer knows that there is likely to be less of a need for the product moving forward, the buyer's product spending allocations may total less than 100% to reflect a decrease in spending on that product for the next measurement period. Alternatively, product allocations may reflect a percentage of spending moving forward, such that a 20% allocation reflects a desire to purchase 20% of the buyer's future needs for that particular product. In circumstances where the product allocations reflect a percentage of spending moving forward, such allocations would have a maximum value of 100%, though the buyer might still have a total of less than 100% to present a conservative estimation of their purchasing (e.g., allocations that reference a purchase of a minimum spending allocation on a product, rather than a goal value). These initial allocations may also be derived from the supplier RFP responses 1508. For example, when considering a purchase plan, the buyer may be presented only with products that are associated with suppliers that responded to the buyer's RFP. In some circumstances, this may result in alternative products being suggested to the buyer for the initial allocation, as the buyer's current supplier may not have responded to the RFP. Additionally or alternatively, certain optimization techniques may be performed to generate the initial allocations. For example, the initial allocations may be modified to provide the buyer with a lowest overall cost based on the seller RFP responses received, or any other optimization technique as described above. In some embodiments, the buyer may be provided with an interface to select the method of determining the initial allocations, or the buyer may be prompted to manually enter initial values. It should be readily appreciated that various methods, algorithms, and weighting techniques can be employed to generate the initial allocations for generating the purchase plan.

In some circumstances, it may not be possible to derive the initial allocations directly from buyer spend data. For example, products previously purchased by the buyer may no longer be available. In such cases, the initial allocations may make use of the cross-references, such as supplier-provided cross-references, to match the supplier's products to the buyer's current products. Additionally or alternatively, such methods may be employed even when the buyer's current products are available, in order to present the buyer with a full range of selections in the product selection and allocation process.

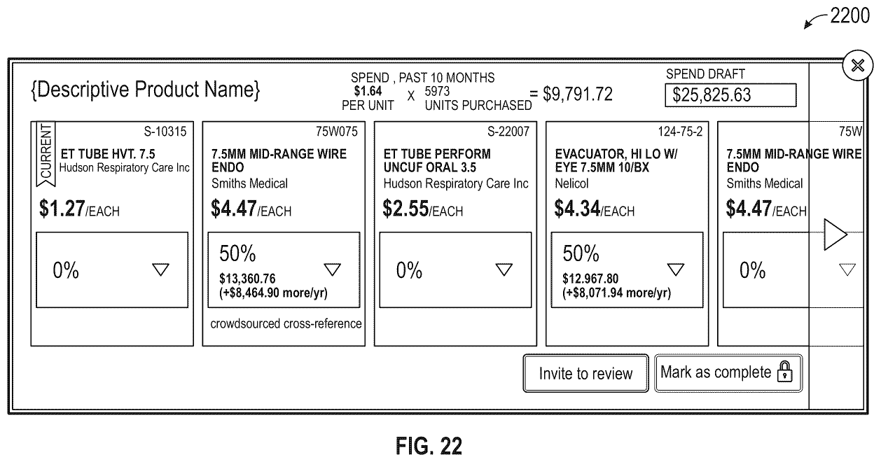

The purchase planner utility 1502 uses the initial allocations 1510, the seller RFP responses 1508, and the list of product cross-references 1512 to present the buyer with an interface for generating the purchase plan 1516. The interface may be populated with a list of sellers that provided RFP responses or a subset of the sellers that provided RFP responses, along with the products referenced in those responses. As described above, buyers may identify a particular category for the RFP, and the supplier may be presented with a list of all products previously purchased by the buyer in the category. The seller may thus recommend product cross-references for the products previously purchased by the buyer. As an alternative, the buyer may provide the seller with particular product selections for which the buyer desires a price proposal. As another alternative, the buyer may be presented with a list of products offered by the seller, alongside of the products the buyer initially selected for the RFP, so that the buyer may select from among product cross-references that may substitute for the initially requested product. An example interface for selecting among product cross-references is described further below with respect to FIG. 22.

The buyer may be provided with an interface to view the initial allocations 1510 and a spending plan derived from those initial allocations in view of the supplier RFP responses 1508. For example, the initial allocations 1510 may be used to determine the pricing of the associated products present in the RFP, and indicate to the buyer how much the buyer would be charged if they made no changes to their current spending. The interface may allow for the buyer. to select cross-reference products and to see the impact of these selections on their planned spending. The buyer may also be presented with the ability to alter performance parameters such as contract durations or product allocations and to see the impact of these alterations on their planned spending, the market share the allocations will afford to each supplier, and the discount levels that may be offered by the suppliers based on the product selections and allocations. Finally, the buyer may be presented with interface controls to optimize their spending according to various optimization parameters. These optimization parameters may further include the ability to “lock” the product selections and spending allocations for a particular product or supplier such that the particular product or supplier is not modified for subsequent optimizations. The interface may thus allow for buyer input 1514 to modify these various parameters and selections to allow the buyer to determine their preferred selections for generation of a purchase plan.

After modifying the product selections, supplier selections, and product spending allocations to the user's satisfaction, the user may confirm the purchase plan. Completion of the purchase plan may result in the generation of a purchase plan 1516 and one or more committed pricing agreements 1518. For example, the buyer may confirm the purchase plan once the buyer is satisfied with the product selections, allocations, and contract terms, or the buyer may indicate to the system that the currently displayed terms should be used to generate a set of contracts for review. Although the purchase plan 1516 is generally described as an artifact generated by the purchase planning utility 1502, it should be understood that the interface output of the purchase planning utility 1502 may also be thought of as a “purchase plan” as the user edits and reviews the interface. In other words, the purchase plan may be thought of as the intermediate product selections and spending allocations generated and viewed by the buyer, in addition to a particular finalized set of product selections and spending allocations generated when the buyer chooses to generate the contracts. The purchase plan 1516 may include planned product selections, spending amounts, and product spending allocations for each of the committed pricing agreements 1518 to ensure that the buyer can be regularly apprised of their progress towards meeting the commitment levels outlined in the purchase plan. A given purchase plan 1516 may be associated with a particular RFP, though other implementations might associate a single purchase plan with all buyer spending in a particular category, or all buyer spending globally. For example, such a category or global purchase plan might be dynamically loaded and updated as the buyer completes multiple RFPs. A purchase plan associated with a particular set of products or product categories may persist across multiple RFPs for the set of products or category, as supplier contracts within a category may be executed at different times. A purchase plan associated with an earlier RFP for the set of products or category may be used to inform purchasing decisions, future purchase plans, and supplier contracts made in as a result of future RFPs for the set of products or category. The term purchase plan should be generally understood to refer to a set of one or more spending allocations for one or more products. These products may be included in a single category, across multiple categories, in a user defined category, or by any other method of organizing or grouping products within the system. Purchase plans may be displayed in an interface as the user completes a purchase planning process, or purchase plans may be stored for later reference and used to measure ongoing spending against the purchase plan. The buyer may be provided with regular status reports and updates based on the purchase plan to notify the buyer if they are on track to meet their planned spending.

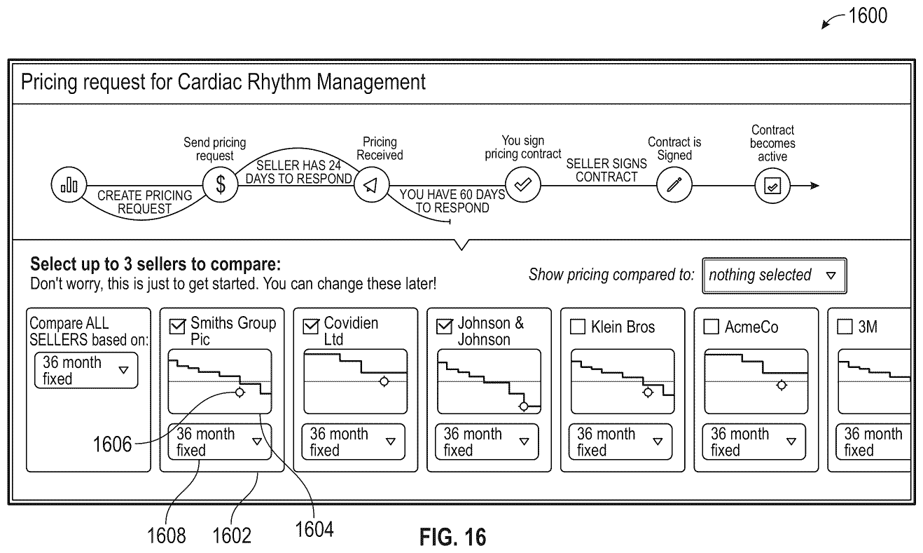

FIG. 16 depicts a screen capture of an interface 1600 for selecting suppliers for comparison in accordance with some example embodiments. Prior to generating the purchase plan, the buyer may be presented with the opportunity to select a subset of suppliers for review and optimization. Additionally or alternatively, the interface 1600 may be provided to allow the buyer to perform a direct comparison between suppliers, separately and distinctly from the purchase planning process. For example, the buyer may use the interface 1600 to select suppliers for a best estimate comparison in a single graph or chart. The interface 1600 provides a display whereby the buyer may select from the suppliers that have responded to the RFP, for inclusion in the purchase plan. The buyer may also be presented with the option to select certain contract parameters such as, in the present example, contract duration. Each supplier may be associated with a particular supplier icon 1602 for selection. For example, in the present display, each seller has a checkbox icon the user may mark to select the supplier for comparison. Each seller may also be accompanied by a graph 1604 that illustrates the supplier's discount level for a particular contract parameter. For example, the interface 1600 displays the supplier's price levels as market-share commitments increase. The graph 1604 may also include a marker 1606 for indicating the best discount offered by that supplier. The marker 1606 may not be presented on a displayed graph if the best discount is offered by a contract with different parameters than displayed. For example, if the supplier's best discount is offered on a 48 month duration contract, the marker 1606 would not be displayed on the actual line of the graph associated with a 36 month duration contract. The buyer may be provided with an interface control 1608 for adjusting these parameters, such as the duration in the present example, to modify the displayed graph.

When selecting suppliers for entry into the purchase planning interface, the buyer may also be presented with additional information about each supplier. For example, the buyer may be shown each supplier's ability to cover the buyer's planned spending in a particular category. Alternatively, the purchase planning interface may examine prices for each seller suggested cross-reference for each duration, contract type, market share, or the like provided in a pricing response to determine a maximum discount level and suggested spending. The initial comparison may thus provide high-level estimates of seller coverage, likely spending, and savings offered by each seller. The interface may further identify the minimum commitment parameters that would generate the best pricing, to allow the buyer to select the lowest commitment level that achieves the best discount level and to use the associated target market share, duration, and contract type as an initial allocation.

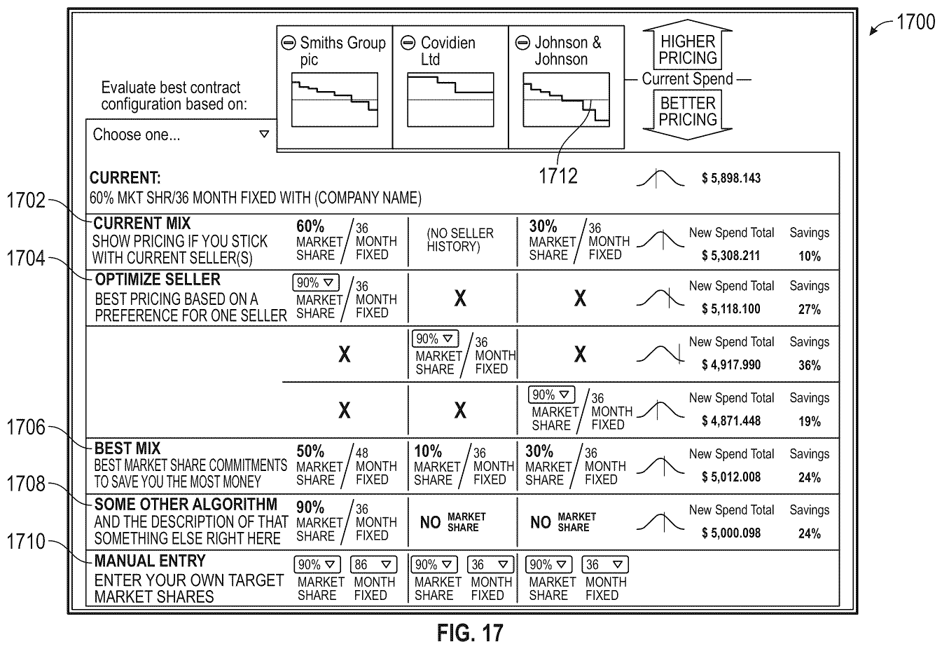

FIG. 17 depicts a screen capture of an interface 1700 for generating initial allocations for a purchase plan in accordance with some example embodiments. As described above, the user may be presented with a set of initial values to generate initial allocations for a purchase plan. These initial values may be derived from previous buyer spend data, or in response to selection of a particular optimization technique. The interface 1700 provides a buyer with the ability to select how the initial allocations will be generated. In the present example, the interface is populated with the user's current spend data for the product or set of products, along with data for selected suppliers, such as suppliers selected using the interface 1600 described above with respect to FIG. 16.

The interface 1700 displays to the buyer several interface controls for selecting a contract configuration. Each interface control may be displayed along with an example optimized set of contract parameters associated with the interface control, along with an estimate of the total savings provided by the mix of contracts associated with that interface control.

In the present example, the buyer may select the current mix control 1702 to populate the purchase plan with pricing based on if the buyer stays with their current suppliers. In the instant plan, that would result in the buyer providing a 60% market share commitment to Supplier A, and a 30% market share commitment to Supplier C. Since the buyer does not currently buy any products that are the subject of the RFP from Supplier B, the appropriate field is left with a blank market share commitment and the statement “No History”, to indicate as such.

The buyer may also select a control to optimize a contract mix for a particular supplier. This optimize supplier control 1704 allows for the buyer to populate the initial allocations with data that will maximize the discount for a particular supplier. Since optimizing for a first seller may typically result in sub-optimal pricing for other suppliers, the optimize supplier control 1704 may only allow for selection of a single supplier at a time.

The buyer may select a best mix control 1706 to optimize the initial allocations to result in a highest savings for the buyer. This control may identify the optimal mix by measuring the discount across various permutations and combinations of product selections and contract parameters for all of the selected suppliers. For example, the purchase planner may conduct a “Monte Carlo” simulation, simulating discount levels over ten-thousand or more possible contract scenarios, and presenting the scenario with the greatest overall savings to the user for use as the initial allocations, or various other combinatorial optimization algorithms may be employed to determine maximum overall savings for the buyer. As another example, a set of heuristics may be used with a combinatorial optimization algorithm to lower the complexity of the optimization process.

The interface 1700 may also include various other controls 1708 for various other optimizations not explicitly displayed in the interface 1700. For example, alternative optimization techniques might optimize for selection of highest rated products, selection of products that provide maximum sustainability or minimal environmental impact, selection of products from suppliers that meet certain diversity criteria, or any other method that may rely on various data analysis techniques.

The interface 1700 may also include a control or set of controls to allow the buyer to manually input values. These manual input controls 1710 may allow for the buyer to select contract performance parameters such as manual product selections and spending allocations, or a contract duration for each supplier, and use these selections to provide the initial allocations.

The interface 1700 may also display a series of graphs 1712 associated with each supplier. As described above with respect to FIG. 16, supplier discounts may be represented as graphs with a first axis for a discount value, and a second axis for a contract performance parameter (e.g., market share commitment). The graphs 1712 depict the buyer's discount level, with a line representing the buyer's performance based on previous spending levels.

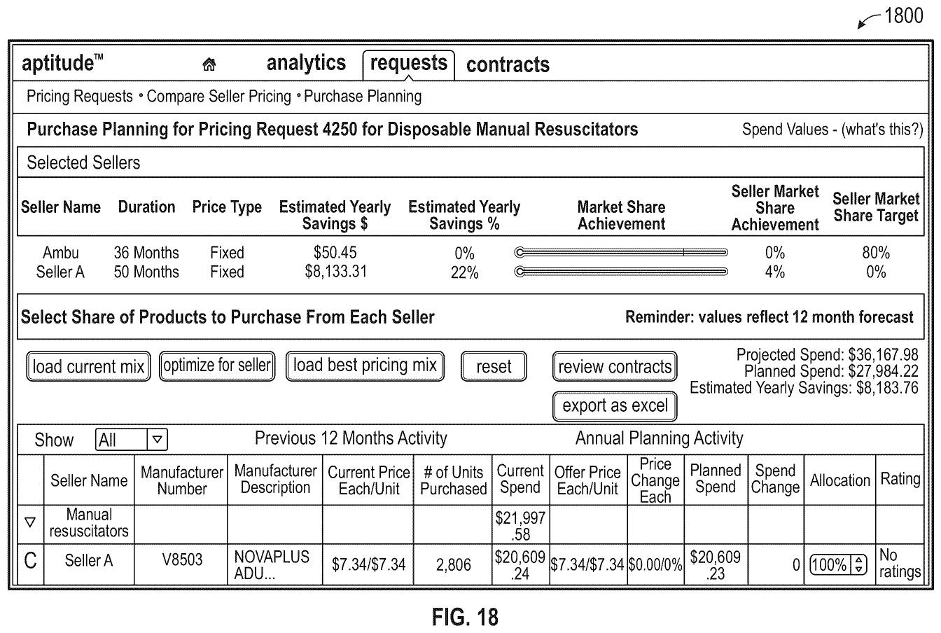

FIG. 18 depicts a screen capture of an alternative interface 1800 for selecting products and product spending allocations for a purchase plan in accordance with some example embodiments. As with the interface 1700 described above, the interface 1800 provides the ability for the buyer to select an initial allocation for later modification and generation of a purchase plan. This initial allocation may be performed according to a variety of factors, such as selection of a current mix, optimization for maximum savings, or manual input. The interface 1800 also illustrates how achievement may be measured towards a target goal. “Thermometer” displays may represent a market share achieved to date for the purchase planning operation, as compared to a target market share goal.

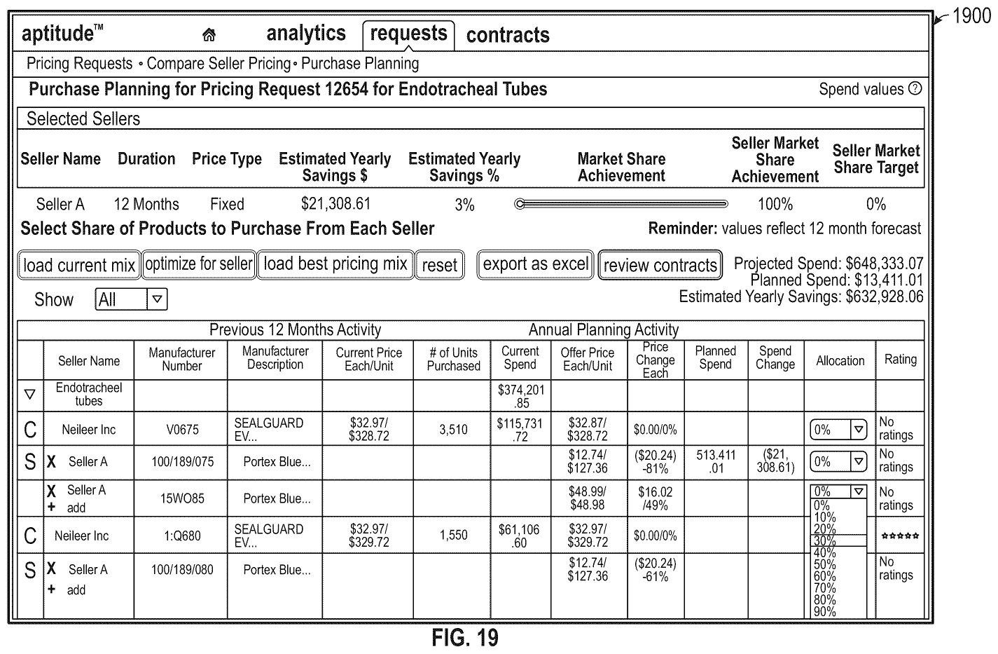

FIG. 19 depicts a screen capture of an interface 1900 for modifying allocations associated with a purchase plan in accordance with some example embodiments. As described above, the buyer may be presented with an initial set of allocations based on a various factors. These initial allocations may be presented to the buyer for modification. As described above, the purchase plan may include both a final artifact generated by a utility for ongoing measurement and monitoring of spending, or an intermediate construct used for simulation and/or planning purposes as the buyer interacts with the purchase planning utility. These initial allocations may thus function as a starting point, allowing the buyer to modify the products selected, the spending allocations for each selected product, the suppliers selected, and the associated contract performance parameters and see the results of these modifications dynamically. For example, the interface 1900 depicts a set of products and available cross-reference products. The buyer may select which of these products they wish to purchase by adjusting the allocations presented in drop-down menus, and how much of their spending for that particular set of products they wish to allocate to each product. As these allocations are updated, the buyer may be provided with updated pricing based on the new allocations. The buyer may be further presented with indicators indicating that some products are seller-identified cross-references, crowd-sourced cross-references, rating-derived cross-references, or products that are currently purchased by the buyer.

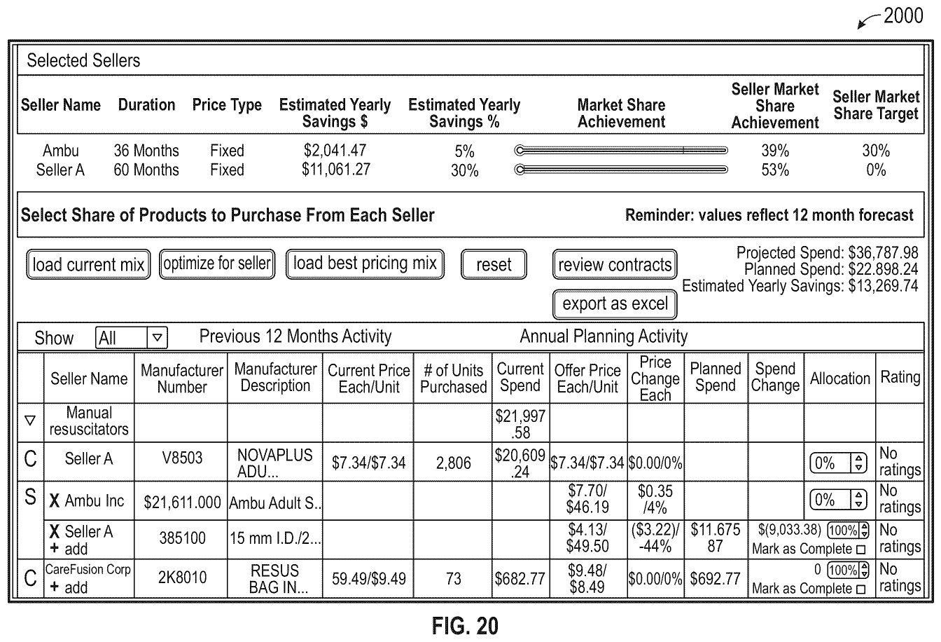

FIG. 20 depicts a screen capture of an alternative allocation modification interface 2000 in accordance with some example embodiments. The interface 2000 provides another example of an interface for modifying allocations prior to generation of a purchase plan. The interface 2000 shows the dynamic impact on market share across two sellers as product selections and market share allocations are changed in the interface. As above, the buyer may be presented with an interface 2000 that allows for optimization of the product selections and spending allocations based on various factors, or manual modification of said allocations.

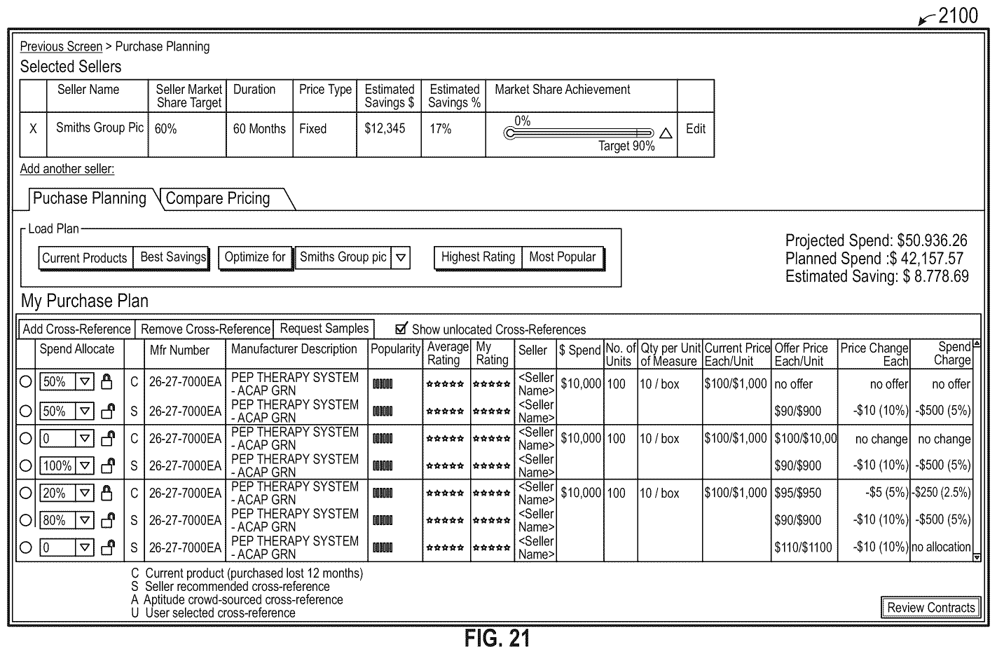

FIG. 21 depicts a screen capture of an example purchase plan interface 2100 in accordance with some example embodiments. The interface 2100 shows a purchase plan that allows for modification or optimization. In the instant example, several products have been selected and had spending allocated, and the buyer may select the “review contracts” interface control to proceed with generation of contracts based on the selected products and spending allocations. As above, the buyer may be presented with the ability to modify the product selections and spending allocations and/or optimize for alternative factors as provided in the interfaces 1900 and 2000. Cross-reference products may be presented to the user with icons indicating the source of the cross-reference. Contract parameters, such as the market-share commitment offered to each supplier, may be derived from the product selections and spending allocations selected by the buyer. In some embodiments, the buyer may go through multiple optimization steps, such as optimizing for one product selection or one supplier at a time, and then “locking” the completed selection. After locking the selection, the buyer may perform a new optimization to optimize the remaining, unselected options. The buyer may proceed through multiple iterations of this process until all selections have been completed.

FIG. 22 depicts a screen capture of a product selection interface 2200 in accordance with some example embodiments. The product selection interface 2200 allows for a buyer to select one or more products that correspond to a particular need of the buyer. For example, one or more products may be identified from the buyer's previous spending in the category associated with the RFP, and, based on the responses received from suppliers, the buyer may have several selections to choose from to meet their need for the particular products identified based on their previous purchases in the product category. These products may be identified as cross-references by the supplier in response to the RFP, or the products may be identified as cross-references via other methods as described above. The buyer may thus decide how their spending should be allocated across the products they are offered. As described above, the buyer may be presented with an initial set of product selections and spending allocations which may then be modified, or the buyer may make manual selections without an initial allocation.

The interface 2200 shows a set of products and cross-references that relate to a product currently being purchased by the buyer. The cross-reference products may be provided by the suppliers (e.g., the supplier may indicate in an RFP response which of the supplier's products are valid cross-references for a product in the RFP), by the market platform (e.g., the market platform may analyze buyer spending data or buyer purchase planning selections to determine which products are most frequently selected as cross-references), or by other users (e.g., other users may indicate that they use a particular product as a cross-reference for a first product). The interface 2200 may allow the buyer to allocate their spending across these various products, or to select a particular product they wish to purchase for this cross-reference. As described above, the buyer may choose to allocate greater than or less than 100% of their spending for a particular set of products if the buyer anticipates an increased or decreased demand as compared to previous measurement periods. The interface 2200 may also display the price of each product and a discount level for a particular pricing tier offered by the supplier of the product. The interface 2200 may allow the buyer to select a particular product to obtain additional data about the product. For example, selecting one of the cross-references may take the buyer to an information page about the product. The interface 2200 may thus allow for allocations to be made to the purchase plan at an individual product level, although alternative embodiments may be implemented where allocations are made at a product category level, or as a set of product categories.

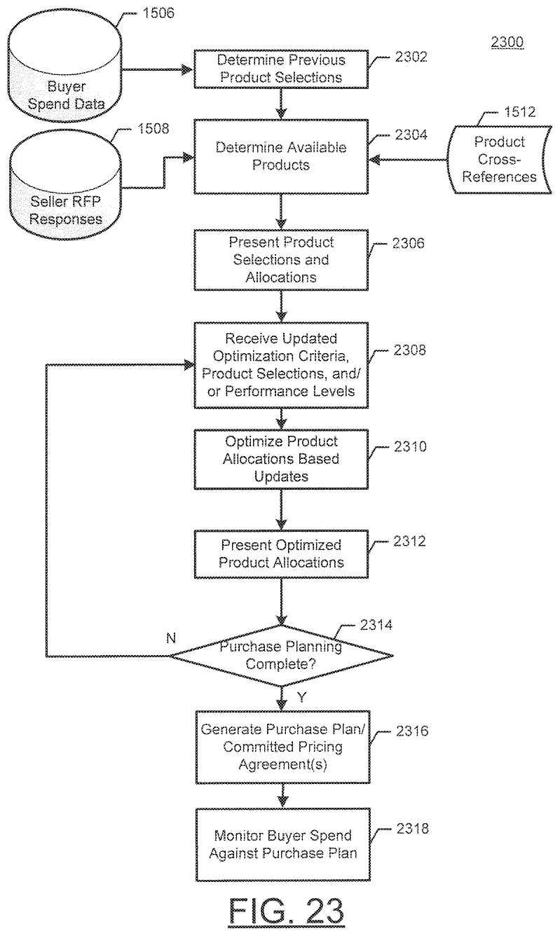

FIG. 23 depicts a flow diagram of an example method 2300 for generating a purchase plan in accordance with some example embodiments. As described above, a buyer may receive a set of pricing proposals in response to an RFP. A market platform may provide a framework or utility for analysis of these pricing proposals to determine which proposals the buyer should select to optimize their spending and maximize value. As described above, optimization may include minimizing overall costs, minimizing costs for a particular supplier, minimizing a change from current spending patterns, minimizing the number of suppliers, maintaining relationships with current suppliers, selecting a highest-rated selection of products, or any other method of selecting particular proposals, products, and performance levels for buyer spending. The method 2300 describes a process by which a buyer may generate a purchase plan that provides the buyer with a guide for which products to select and how to allocate their spending in order to reach the optimized spending determined by the buyers purchasing preferences. The method 2300 may be linked to spending for a particular RFP. In other words, the generated purchase plan may correspond to a particular product, set of products, product category, or the like requested by the user, for which the user has received responses from one or more suppliers. Although the method 2300 is generally discussed with respect to specific pricing proposals received from suppliers, alternative embodiments may allow the user to estimate or preview pricing proposals. For example, the market platform may provide the user with data for typical pricing proposals received in a category before the user even generates the RFP, so that the user may input test data to determine if a RFP is worthwhile (e.g., whether suppliers for the products sought are offering enough of a discount to justify an RFP).

At action 2302, previous product selections may be determined from the buyer's previous spend history. The initial product selection may correspond to products previously purchased by the buyer within the category identified by the RFP submitted by the buyer. For example, the initial product allocations may be representative of previous buyer product purchases in the category, at previous spending allocations. In the present example, buyer spend data, such as the buyer spend data 1506 described with respect to FIG. 15, is used to determine the previous product selections. However, alternative data could also be used to derive the initial allocations. For example, for a new buyer with no existing spend history, initial goals or product selections, might be determined using spend data from other buyers with similar characteristics, buyers from affiliated organizations, buyers of a similar number of employees, market shares of leading suppliers in a category, buyers with a similar number of facilities, buyers of a similar practice type (e.g., cardiologists, surgeons, emergency rooms), or by various other factors.

At action 2304, a set of available products are determined As described above with respect to FIG. 15, in some circumstances buyers may not be able to select products that exactly conform to their previous purchasing habits. For example, products may be discontinued by suppliers, suppliers may go out of business, the supplier may not have responded to the buyer's RFP, or products may be out of stock. The method 2300 may thus determine which products to display to the buyer as initial allocations based on products that are indicated as available either in seller pricing proposals (e.g., RFP responses), or using a list of product cross-references. For example, if a buyer previously purchased a product that has since been discontinued, the method 2300 may examine the list of cross-reference items offered by sellers that responded to the RFP, and allocate spending to those cross-reference items. The products previously purchased by the user may be presented in a disabled or “grayed out” format, displaying to the buyer that the product they previously purchased is no longer available, while also presenting alternatives to the buyer to meet the need previously filled by the unavailable product. Alternatively, if a buyer desires a product that is provided by a seller that did not respond to the RFP, spending may be allocated to a cross-reference product offered by a seller that did respond. In some embodiments, the seller pricing proposals may include suggested product cross-references which may have initial spending allocated as appropriate. In additional or alternative embodiments, the interface may provide an icon indicating that a previously purchased product is unavailable, and prompt the user to select a cross-reference item. The initial list of products may include all products purchased by the buyer in a particular time period (e.g., the last 12 months), and spending may be allocated to those products according to the market share derived from the buyer's spend history. Spending allocations for particular products may be solely designated for previously purchased products, or they may be apportioned across product cross-references.

At action 2306, the product selections and spending allocations are presented to the buyer as a set of initial allocations to provide the buyer with a starting point for creating their purchase plan. As described above with respect to FIGS. 15-22, the initial allocations may be determined according to a variety of methods and optimization algorithms, or they may be manually provided by the buyer.

At action 2308, an update to product selection, optimization criteria, or product purchase allocations may be received. As described above, the buyer may be presented with the ability to alter the initial allocations to see the impact that the modifications will have on their overall spending. As such, the buyer may select alternative cross-reference products, adjust contract durations, adjust sales volume or product spending allocation levels, select different suppliers, select alternative optimization methods, or the like.

In some embodiments, manual modifications and updates may cause alterations in other sections of the interface. For example, adjustment of a product selection may alter target market share goals for the each supplier in that category, representing the effect of buying that particular product at that particular price from that particular supplier, rather than from another supplier. Adjustment to product selections or contract performance levels (e.g., market share commitments) may change the active discount level for one or more sellers. This may cause an update in the prices associated with the previous allocations.

Selection of an alternative product may thus result in recalculation of market share for each supplier, recalculation of an overall projected savings, recalculation of projected spend with the supplier, recalculation of the product pricing tier, and recalculation of product prices for previously allocated products in the event the product pricing tier changes.

Alternatively, the buyer may choose to select certain goals prior to generating the purchase plan. These goals may include goals for contract duration, price discount levels, supplier market shares, overall percentage savings, minimization of conversion costs, or the like. The buyer may specify these goals and be presented with a set of initial allocations that meet those goals, or the buyer may arrive at initial values via any other method as described above. These goals may inform various other characteristics of the purchase plan. For example, the buyer may choose to set a particular supplier at a particular market share level, and have pricing displayed by the purchase plan utility reflect that market share level. Upon completion of any changes made to the purchase plan by the buyer, the purchase plan may notify the buyer if the previously defined goals were met based on the product selections and spending allocations chosen by the buyer. For example, if the buyer chooses a market share goal for a particular supplier and receives pricing based on that market share, but then selects products and spending allocations that will not reach the market share goal, then the pricing utility may notify the buyer that the selected purchase plan does not meet the specified goals. The purchase plan may make suggestions to the buyer to assist the buyer with selections that will meet those goals. Alternatively, the system may notify the buyer that they are eligible for higher discounts (e.g., if the buyer's selections reach a higher discount tier for a particular supplier), and thus the buyer may be entitled to an additional discount. In this manner, the system may provide feedback either dynamically as modifications are made to the purchase plan or upon a request by the buyer to recalculate the values based on new product selections and spending allocations.

At action 2310, adjustments are made to the interface based on the modifications performed at action 2308. In this manner, the buyer may be presented with a real-time view of the impact of these changes on their planned spending.

At action 2312, the adjustments are presented to the buyer, and at action 2314 the buyer may be prompted to determine if the user has completed the purchase planning process. For example, the buyer may request that the purchase planning utility generate a set of committed pricing agreements based on the product selections and spending allocations displayed in the interface, or the buyer may use a “confirm purchase plan” interface control to indicate acceptance of the purchase plan. If the buyer indicates that purchase planning has been completed, the method proceeds to action 2316. Otherwise, the method returns to action 2308 to receive further adjustments to the product selections, allocations, and/or optimization criteria.

At action 2316, the purchase plan may be generated and stored for use as a set of ongoing metrics to track spending by the buyer. Generation of the purchase plan may also cause generation of one or more committed pricing agreements for execution by the buyer and seller. The terms of the committed pricing agreements may conform to the terms selected by the buyer during generation of the purchase plan. For example, if the product selections and spending allocations for a buyer result in a 50% market share for a certain supplier in the purchase plan, the committed pricing agreement may be generated with terms requiring a 50% market share commitment, and if the supplier offers a particular discount at 50% market share, that discount will likewise be memorialized in the committed pricing agreement. As described above, purchase plans may be associated with a particular category, or each purchase plan may be associated with a separate RFP, resulting in the potential for multiple purchase plans in the category, though typically each supplier may only have one active contract for a particular product, set of products, or product category, depending upon the implementation of the process. Purchase plans may persist across the category, such that product selections and spending allocations made in a first purchase plan are reflected in other purchase plans for the category.

At action 2318, buyer spending may be monitored using the purchase plan as a metric. For example, buyer spending may be tracked against the commitment levels specified in the purchase planner so that the buyer may be made aware as to whether they are conforming to their purchase plan. Ongoing measurement in this manner may provide the buyer with the ability to adjust their spending to conform to the plan in advance of compliance measurement periods, to ensure that they are on track to meet their planned spending levels.

FIG. 24 depicts a screen capture of an example of a pricing rules definition page 2400 in accordance with some example embodiments. To assist the supplier with responding to buyer RFPs, the market platform may offer various tools and techniques for generating product pricing data for consideration by the buyer. These tools may include an array representation of discount levels for products within a category, with market share commitment levels and sales volume numbers along the axes of the array. These tools may also provide an interface for adjusting other contract parameters and/or discount terms that may influence product pricing, such as contract duration and whether the pricing model is variable or fixed. Particular pricing models may be established for each product in a category or the category as a whole and these pricing models may be provided in a format that allows for saving, loading, reusing, and copying of price information to simplify the process of responding to an RFP. Pricing models may also be associated with particular buyers or buyers of a particular size, such as to prevent the supplier from having to recreate the entire pricing model from scratch for every RFP. For example, a particular pricing model may be associated with a certain size buyer, a certain type of buyer (e.g., a pricing model for non-profits or university teaching hospitals), or based on other buyer characteristics.

The interface 2400 allows a supplier to adjust various discount terms and contract parameters that are used to calculate a discount percentage for use in generation of a price response to a buyer. These contract parameters may include, but are not limited to, the duration of the contract (e.g., 24 months, 36 months, 48 months), the type of price adjustment model (e.g., fixed prices or variable prices), the volume of sales promised by the buyer for the particular products or product categories (e.g., $100,000 to $999,999 of spend in the category, over $1,000,000 in the category), and the market share offered by the buyer for the particular products offered by the supplier (e.g., 10%, 20%, 50%). More complex discount terms may also be employed. For example, a particular set of parameters might offer an additional discount for a certain amount of spending in a certain time period (e.g., a 5% discount for achieving $100,000 of spending within 6 months or a 10% discount for achieving $200,000 spending within 9 months). The interface 2400 allows for the supplier to adjust discount terms for each of these contract parameters individually. For example, in the interface 2400, the supplier is offering a 5% discount for a 24 month duration contract, a 10% discount for a 36 month duration contract, a 1% discount for a 48 month contract, and no discount for a 60 month contract. The supplier is also offering discounts based on sales volume and market share. The supplier may use this interface to enter discount terms in the appropriate field to populate a price array with an associated discount. A total discount may be determined by taking the sum of the individual discount terms for each contract parameters, with a maximum discount level of 100%. Although 100% is the maximum discount level, the sum total of individual discounts may exceed 100%, with the 100% maximum discount operating as a price floor. For example, three different discount parameters for a given set of discount terms may individually have values of 40%, 50%, and 20%, which would result in a total sum of 110%, which would be lowered to the maximum discount level of 100%. However, if another contract term with a negative discount value (e.g., a long duration contract) was selected with a discount value of −30%, then the final discount value would be (40+50+20)-30, or 80%. As another example, the current interface selections as depicted in FIG. 24 would result in a 48 month duration contract for $201 of spend with a 50% market share having a total discount of 69%.

Notably, in the present example, discount terms are related to a percentage of a maximum price discount level. As such, the larger the percentage, the greater the total discount received by the supplier. For example, the supplier may specify a minimum and maximum price for each product. The available discount may thus be represented by the difference between the maximum and the minimum. As such, the final price may be determined by multiplying the difference by the total discount, and then subtracting the result from the maximum price for the product. In alternative embodiments, various other methods of calculating a discount using the array may apply. For example, field entries may relate to a multiplier for the purchase price (e.g., 99%, 98%, 95%), and each of the individual discounts (e.g., discount for contract duration, discount for market share, discount for spend volume) may be multiplied to arrive at the final discount number, such that a lower percentage results in a lower price for the buyer.

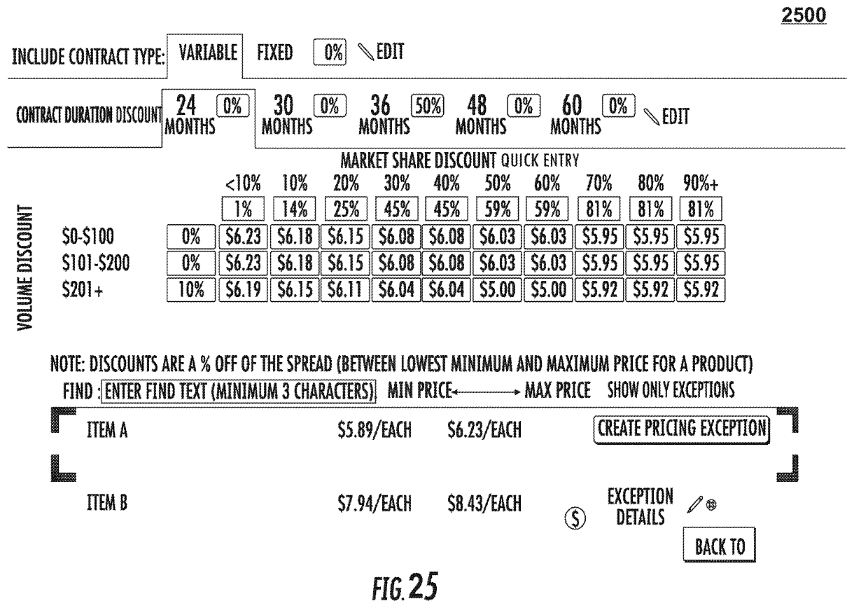

FIG. 25 depicts a screen capture of an example of a set of defined pricing rules applied to a set of products in accordance with some example embodiments. The example interface 2500 depicts a series of products, Item A, Item B, Item C, and the maximum and minimum prices associated with each. Notably, the instant figure provides an example of negative discount terms. In the present example figure, the supplier has indicated that contract durations of 48 months and 60 months are associated with a −100% discount value, implying that the supplier does not wish to enter into any long-term contracts beyond 36 months. Additionally or alternatively, the supplier may be presented with the option to disable certain terms (e.g., certain contract durations) that the supplier will not support. This negative term may be subtracted from any positive discount values, although the use of a negative 100% does not necessarily imply that no discount will be provided. For example, the buyer may select terms that add up to greater than a 100% discount value, such that even after subtracting 100% some discount remains. These maximum and minimum prices may be used in conjunction with the discount percentage specified by the pricing rules to arrive at a final price for each item, and the maximum and minimum prices may establish a ceiling and a floor for product prices, respectively. In other words, if the final discount value is greater than 100%, the price will not be lowered beyond the minimum price, and vice-versa for the maximum price. For example, if a given item has a price range of $20.00 to $25.00, the maximum discount off of the maximum price is $5.00 ($25.00-$20.00=$5.00). If a 10% discount percentage was arrived at based on contract duration, market share, and product volume discounts, then the price of the product would be $24.50 ($25.00-(10%*$5.00)). The interface thus allows the supplier to select a particular product (e.g., Item A is selected in the instant example interface 2500), and see the prices associated with that item according to an array and tab representation, where individual discounts are associated with one or more array axes or tabs. Upon selection of a particular item, the array is populated with the price of said item at each discount level, allowing the supplier to review the effect of different discount level offers on the overall price of the product.

The prices of the products, including minimum and maximum prices, may be manually input by the supplier, or the prices may be accessed through a file or database. For example, the user may provide a comma delimited file with maximum and minimum prices for each product offered by the supplier, and the system may allow for updating of one or more of the pricing models and/or price responses in response to receiving an updated file. In some embodiments, maximum and minimum prices are associated with a particular contract or agreement between the buyer and the supplier.

The supplier may also override pricing data received from such a file or database. For example, the supplier may wish to offer a price below the normally established minimum price for a particular product for a particular buyer. The interface 2500 may thus provide for creation of a “pricing exception” to allow the supplier to specify a set of discount terms for the particular product that is different from a price received from a pricing model. For example, the exception may provide a different set of discount parameters (e.g., a sub-pricing model) used by the pricing utility to create the set(s) of product prices to include in the particular purchase contract.

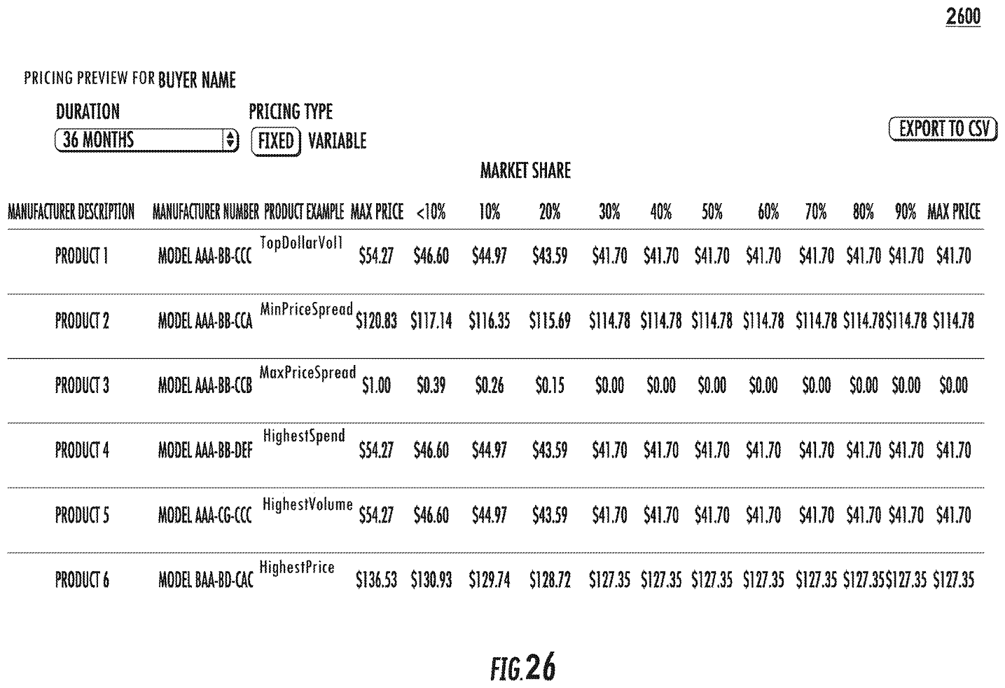

FIG. 26 depicts a screen capture of another example interface 2600 for providing definition of pricing rules in accordance with some example embodiments. The example interface 2600 depicts a pricing array as established based on discount terms entered for different contract parameters, along with a list of products and the maximum and minimum price values for each of the products. In the interface 2600, product discount levels are shown via the pricing array rather than absolute product prices. In some embodiments, the pricing array may be altered to display product prices in response to selection of a product via the interface.

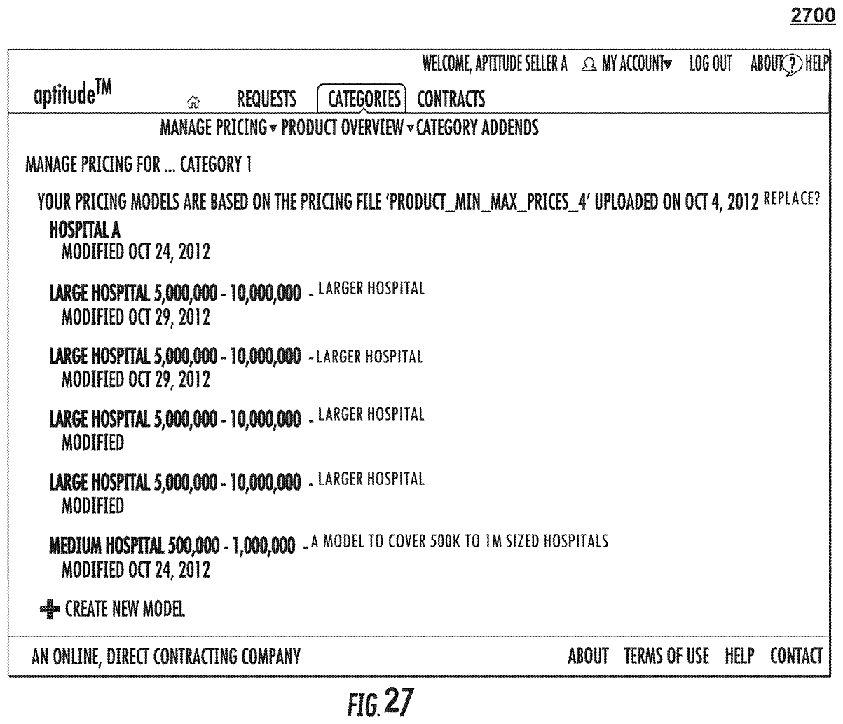

FIG. 27 depicts a screen capture of a pricing model selection interface 2700 in accordance with some example embodiments: As described above, pricing models may be saved for later review and access by suppliers. For example, a supplier may establish different pricing models for different customer types (e.g., large entities, small entities, buyers that have been customers for more than 10 years), and decide which pricing model to apply or as a starting template to generate a price response to a particular RFP received from a buyer. In some embodiments, the supplier may also establish rules for determining which buyers receive which price responses based on which pricing models (e.g., if the buyer has over 1,000 employees, apply a large entity pricing model to generate the price response, otherwise if the buyer has been a customer for more than 5 years, apply a long-time customer pricing model). These pricing models may establish discount terms for different contract parameters, as described above. The pricing model selection interface 2700 may allow for individual access and modification of these pricing models. In some embodiments, price data may be stored in a separate file, database, or other format, so that price data may be updated without the need to individually edit each pricing model. For example, a supplier may regularly update their prices using a spreadsheet, and provide the spreadsheet to update prices for each of the pricing models the supplier had previously established. As another example, price data may be supplied via a comma delimited text file, containing at least product identifiers, minimum prices, and/or maximum prices.

As described above, pricing models may also be associated with price exceptions from this price model, such as the sub-models described above. These exceptions may be stored as part of the pricing model or an associated price response. The system may also provide for the ability to update prices, such as by uploading a new price file.

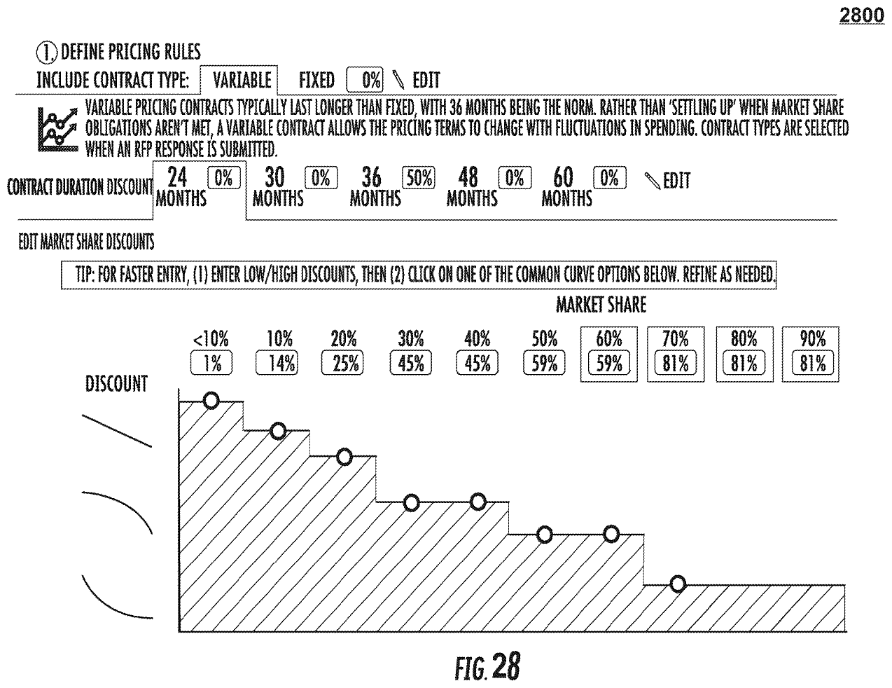

FIG. 28 depicts an example of a curve selection interface in accordance with example embodiments of the present invention. Rather than enter individual discount terms by hand, the supplier may instead choose to select a discount curve for a particular contract parameter. For example, the supplier may select a curve with a steep slope that levels out as discounts approach a certain value, or the supplier may wish to offer minimal discounts with an increasing rate of discount past a certain achievement level. The curve selection interface allows for the supplier to select a curve that corresponds to the discounts they would like to assign for a given contract parameter, without requiring the supplier to manually enter each discount term. For example, the depicted interface offers three curve options. The first curve with a constant slope reflects discount levels that increase at a constant rate as achievement increases. The second curve with a gradually increasing slope depicts discounts that increase faster as achievement increases, and the third curve with a gradually decreasing slope depicts discounts that decrease as achievement approaches a certain value. The supplier may thus select one of these curves and the discount terms may be automatically populated with values that reflect the selected curve. Alternatively, the supplier may utilize this interface to visualize discount terms manually entered into the pricing array, such that the depicted curve shows the discount levels associated with each tier of the depicted contract parameter. The interface may further provide for manual adjustments to individual price levels after the curves are established.

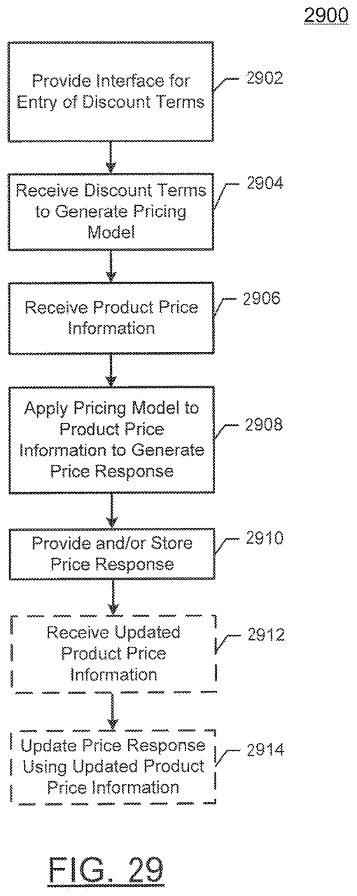

FIG. 29 depicts a flow diagram of an example method 2900 for generating a price response in accordance with some example embodiments. The method 2900 operates to generate a price response (e.g., a set of product prices for a particular buyer, with discounts applied based on contract parameters) using a received set of contract parameters and a set of product price information. In some embodiments, the pricing model is derived using data received via interfaces such as described above with respect to FIGS. 24-28. Price responses generated in this manner may be provided to buyers as a response to RFPs generated by the buyers. The price response may be used by the buyer to plan product purchases and determine the impact of different contract parameters on the product prices offered by the supplier. In this manner, the pricing model and price response may simplify the RFP process for both the buyer and the seller, by providing the buyer with a unified format for comparison of different contract parameters, and providing the seller with an accessible, reusable data entry format to apply and adjust discounts for a variety of products based on a variety of contract parameters.

At action 2902, an interface is provided for entry of contract discount terms. The interface may include one or more particular contract parameters, along with fields to enter discount terms for each parameter. For example, the interface may be provided as an array representation as described with respect to FIGS. 24-28. This array representation may include a plurality of axes, with axes associated with particular contract parameters. The interface may further include one or more “tabs” allowing the supplier to input additional discount terms for different parameters, with particular tabs associated with particular array representations. Each field may allow for input of a discount percentage associated with a particular value of a particular contract parameter (e.g., for a parameter “market share” and a value “20%”, a discount term might be “I 0%”). The interface may further allow for the supplier to select additional parameters, so that values for those additional parameters may also be considered when determining product pricing. For example, the interface may include a series of check boxes allowing the supplier to select whether parameters such as “market share,” “contract type,” “spend volume,” “buyer size,” or other values will be associated with discount terms. Although the term “array” is generally used to describe the interface for entry of discount terms and a resulting pricing model, the actual implementation may be more than two dimensions, with each dimension associated with a contract parameter type. As such, the array may function as a grid or a multi-dimensional array, with values for the contract parameters functioning as array indices.

At action 2904, discount terms are received via the interface provided at action 2902. For example, a supplier may enter particular discount terms for contract parameters that are relevant to an RFP received from a buyer. In some embodiments, the discount terms may be entered in response to a particular RFP, while in other embodiments the discount terms may be provided separately from any particular RFP. For example, the supplier may establish a “default” set of discount parameters for responding to incoming RFPs. In some embodiments, the default discount parameters may be presented for modification by the supplier prior to responding to an RFP. In yet further embodiments, the supplier may create one or more rules for associating particular sets of input discount terms with particular scenarios, such as particular sizes or types of buyers. For example, the supplier may indicate that a particular set of discount terms should be used as a default when the buyer is a large entity, or another set of discount terms when the buyer is a non-profit organization. The received discount terms may be used to generate a pricing model as described above.

At action 2906, product price information is received. As described above with respect to FIGS. 24-28, the product price information may be manually entered by the supplier, provided via a file upload, extracted from a supplier database, or by any other method of providing product price information for generation of a pricing model. The product price information may include product identifiers, a maximum product price, a minimum product price, and/or a maximum product discount. In some embodiments, the maximum product discount may be derived from the relationship between the maximum product price and the minimum product price (e.g., subtracting the minimum price from the maximum price to determine a maximum discount). As described above, a discount price floor may be established such that no matter the discount terms, the system may never generate a price lower than the minimum product price specified in a product price file, unless the supplier has established a price exception for the particular product or the particular buyer.

At action 2908, the contract discount terms are applied to the received product prices to generate a price response. As described above with respect to FIGS. 24-28, the price response may include prices for particular products based on different contract parameters. For example, the price response may indicate how a price for a given product will change depending upon market share commitments agreed upon by the user. In some embodiments, the price response may be associated with a particular category of products as described above. The price response may be generated as an array interface populated with price values as described above with respect to FIG. 25. Exceptions to the discount terms may also be defined by the supplier for use with the particular buyer, type of buyer, for a set of one or more products in a category based on product sales margins, or for the particular price response. As described above, these exceptions may cause a deviation from a standard price model, and adjust the discounts applied for certain parameters accordingly.

Discount terms may provide a uniform direction of discount, such that increased achievement for a given contract parameter results in an increased discount for that parameter. However, in some circumstances this may not be possible, or may even be sub-optimal. For example, certain high-demand products may have increasing prices as the quantity ordered increases (e.g., flu vaccines during flu season, certain cancer drugs, etc.) due to scarcity, or suppliers may introduce a penalty for long duration contracts due to concerns about locking in a price for a long time. As such, discounts may not be uniform, and may even reduce as the buyer increases achievement in certain parameters.

At action 2910, the price response may be provided to a buyer, stored for later access, and/or associated with a particular RFP response. As described above, the price response may be provided to a buyer in response to an RFP, and the buyer may utilize the price response to determine the impact of different contract parameters on the price of products purchased from the supplier. In some embodiments, the price response and/or pricing model may be stored for later use. For example, the pricing model may be a “default” model established by the supplier as a baseline. This default model may be later accessed and modified by the supplier to generate responses for particular RFPs.

At action 2912, the method may optionally receive updated price information, such as in the case where a price response was previously generated but not sent to a buyer. In this manner, the buyer may update the price response so that it contains the latest data before entering into an agreement with a buyer. As described above, price information may be provided via a file, over a network, or via various other methods. This price information may be used to dynamically update the prices of products without the need to recreate each pricing model separately. For example, the supplier may update product prices as material and labor costs change. Such a change would result in manually updating each of the pricing models if the prices were stored statically, even though the supplier does not wish to change discount terms for said pricing models.

In some embodiments, the supplier may add new products to an agreement via a category addendum, such as in the case where the supplier adds new products to their inventory or phases out older products and replaces them with new products. In such circumstances, the system may provide rules to ensure that neither the buyer nor supplier is penalized for introduction of these new products. For example, the system might ensure that any products that are newly added to a product category will not have a negative impact on the buyer's market share calculations for that category. This advantageously allows the buyer to be provided with the option to purchase the new product, without causing a negative impact on the measurement and monitoring terms to which the buyer and supplier previously agreed. These new products might be extracted from the category addendum and discount terms generated based on the agreed discount terms of the committed pricing agreement. Product prices may thus be generated for these new products from the category addendum to mirror discount terms applied for other products in the category.

At action 2914, the method may optionally update the pricing models in accordance with the received updated price information. In this manner, individual pricing models may not store static product prices. For example, pricing models may be linked to an identifier for a particular pricing response, where the pricing response includes final prices for products based on performance levels. Pricing responses may also be separately linked to product price lists, such that the price model and the price list are entirely separate from one another. Alternatively, the method 2900 may enable processing to access and update each pricing model, or only pricing models that contain prices that have changed in the updated price data. As such, product discount terms may remain static for a given set of contract parameters while updating as product prices change.

It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-20. (canceled)

21. A system comprising:
one or more computers comprising one or more processors and one or more non-transitory computer readable media, the one or more non-transitory computer readable media having program instructions stored thereon that when executed cause the one or more processors to generate one or more graphical interfaces (GUIs), wherein the one or more computers are configured to:
receive, by the one or more processors, one or more request for pricing (RFP) responses;
derive, by the one or more processors, initial allocations for the one or more RFP responses based on buyer spend data;
display, by the one or more GUIs, a first purchase plan on a purchase planner utility, the purchase planner utility displaying a set of initial allocations as part of the first purchase plan;
enable, by the one or more GUIs, a user an ability to execute modifications to the initial allocations in the first purchase plan displayed on the purchase planner utility;
alter, by the one or more processors, sections of the purchase planner utility based on the modifications to the initial allocations;
display, by the one or more GUIs, a second purchase plan based on the modifications to the initial allocations in the purchase planner utility.

22. The system of claim 21,
wherein the purchase planner utility uses the initial allocations, a seller RFP response, and a list of product cross-references to display the first purchase plan.

23. The system of claim 21,
wherein the purchase planner utility is configured to finalize a set of product selections and spending allocations generated when a buyer chooses to generate one or more contracts.

24. The system of claim 21,
wherein the first purchase plan includes planned product selections, spending amounts, and product spending allocations for each of one or more committed pricing agreements.

25. The system of claim 24,
wherein the purchase planner utility is configured to dynamically load and update the second purchase plan as a buyer completes multiple RFPs.

26. The system of claim 24,
wherein the purchase planner utility is configured to generate a price response on the one or more GUIs by applying a pricing model to product price information.

27. The system of claim 26,
wherein the price response defines a relationship between one or more contract parameters and a set of discounted prices for one or more products.

28. The system of claim 21,
wherein the purchase planner utility operates to determine a set of product selections, market share allocations within the set of product selections and contract commitment values to optimize spending for a buyer for a particular product, particular set of products, a product category, or a set of product categories.

29. The system of claim 21,
wherein the purchase planner utility is configured to display pricing that reflects a market share level of a particular supplier.

30. The system of claim 29,
wherein the purchase planner utility is configured to notify a buyer that a selected purchase plan does not meet one or more selected goals.

31. The system of claim 21,
wherein the purchase planner utility is configured to display a set of committed pricing agreements corresponding to product selections and spending allocations displayed in the one or more GUIs.

32. The system of claim 21,
wherein the purchase planner utility is configured to generate a list of product cross-references.

33. The system of claim 32,
wherein the product cross-references include valid cross-references for one or more pricing responses.

34. The system of claim 32,
wherein the list of product cross-references includes a global list that is equally applicable across all potential purchase plans.

35. The system of claim 21,
wherein the initial allocations include one or more of a buyer's current product selections, supplier selections, and product purchase allocations.

36. The system of claim 21,
wherein the initial allocations are derived from a buyer's current spending on products associated with one or more RFPs.

37. The system of claim 36,
wherein the initial allocations reflect a buyer's product selections, sales volume, and product purchase allocations.

38. The system of claim 37,
wherein the product purchase allocations reflect which products the buyer intends to purchase to meet a need for a particular product identified in one or more RFPs.

39. The system of claim 36,
wherein the initial allocations are derived from a supplier RFP response.

40. The system of claim 39,
wherein the initial allocations are modified by the purchase planner utility to provide the buyer with a lowest overall cost based on a response of a seller RFP.
